(19) United States
(12) Patent Application Publication
(10) Pub. No.: US 2024/0259199 A1
(43) Pub. Date: Aug. 1, 2024

(54) AUTHENTICATION

(71) Applicant: Hewlett-Packard Development Company, L.P., Spring, TX (US)

(72) Inventors: THALIA MAY LAING, Bristol (GB); YONG QI WANG, Birmingham West Midlands (GB); MARK DERMOT RYAN, Birmingham West Midlands (GB)

(73) Assignee: Hewlett-Packard Development Company, L.P., Spring, TX (US)

(21) Appl. No.: 18/564,444

(22) PCT Filed: Jun. 14, 2021
(86) PCT No.: PCT/US2021/037235

§ 371 Date: Nov. 27, 2023

(51) Int. Cl. H04L 9/14; H04L 9/30

(52) U.S. Cl. CPC H04L 9/14; H04L 9/30

(57) ABSTRACT

Examples relate to machine readable storage storing instructions arranged, when processed, to implement authentication using an authenticator, the instructions comprising instructions to: generate, by an initial authenticator, a public key associated with a further authenticator using a secret associated with the initial authenticator and the further authenticator; and output the public key associated with the further authenticator for sending to a relying party.

### BACKGROUND

Authentication of a user via an authentication device is becoming more frequent. This type of authentication is authentication based on ‘what you have’ as opposed to authentication using ‘what you know’, which relies on passwords.

### BRIEF INTRODUCTION OF THE DRAWINGS

Examples will be described with reference to the accompanying drawings in which

FIG. 1 shows an example of an authenticator;

FIG. 2 shows a further example of an authenticator;

FIG. 3 shows an example of a still further authenticator;

FIG. 4 shows an example of a relying party;

FIGS. 5A-C shows a duplicate authenticator-single relying party authentication system and signalling according to examples;

FIG. 6 shows signalling and operations of the authentication system of FIGS. 5A-C;

FIG. 7A-C shows a duplicate authenticator-specific relying party authentication system and signalling according to examples;

FIG. 8 shows signalling and operations of the authentication system of FIGS. 7A-C;

FIGS. 9A-C show a proxy authenticator-single relying party authentication system according to examples;

FIG. 10 shows signalling and operations of the authentication system of FIGS. 9A-C;

FIGS. 11A-C show a proxy authenticator-specific relying party authentication system according examples;

FIG. 12 shows signalling and operations of the authentication system of FIGS. 11A-C;

FIGS. 13A-C show a ring signature authentication system according to examples;

FIG. 14 shows signalling and operations of the authentication system of FIGS. 13A-C;

FIGS. 15-17 show flow charts associated with the authentication system shown in FIGS. 5A-C;

FIGS. 18-20 show flow charts associated with the authentication system shown in FIGS. 7A-C;

FIGS. 21-23 show further flow charts associated with the authentication system shown in FIGS. 11A-C;

FIGS. 24-26 show flow charts associated with the authentication system shown in FIGS. 13A-C;

FIG. 27 illustrates machine readable storage according to examples;

FIG. 28 shows further machine readable storage according to examples;

FIG. 29 shows machine readable storage according to examples.

### DETAILED DESCRIPTION

Authentication of a user via an authentication device using ‘what you have’ is becoming more frequent. This type of authentication is authentication based on ‘what you have’ as opposed to authentication using ‘what you know’, which relies on passwords. However, it is vulnerable to the user losing their device and, therefore, becoming locked out of an account or being denied access or control over an associated resource. To avoid this issue, some users may independently register multiple authentication devices when the account is created. Nevertheless, given the unpredictability of when a user may create an account or otherwise register with an account or control a resource, the user may not have multiple authentication devices available to them during such a registration process. Furthermore, if a user does possess all such authentication devices, there is a risk of losing all of the devices simultaneously.

Referring to FIG. 1, there is shown a view 100 of an authenticator 102. The authenticator comprises a processor 104 and a communication interface 106. The processor can be configured to implement a key generator 108 or other authentication data generator. The key generator is arranged to generate authentication data 110. Examples can be realised in which the authentication data 110 comprises, or is derived from, private-public key pairs. Throughout the description, the key generators are examples of authentication data generators. Examples can be realised in which the authentication data generators generate private-public authentication data.

The key generator is responsive to seed data 112. In the example depicted in FIG. 1, the seed data comprises a secret 114. The secret is shared amongst a set of authenticators (not shown). Therefore, examples can be realised in which the key generator 108 generates authentication data 110 in response to the shared secret 114.

Throughout the application the term authenticator should be interpreted as an authentication device or system such as, for example, hardware, authentication software or a combination of authentication hardware and software. Such authentication software can comprise an authentication application or authentication app. For example, the authenticator could comprise a Yubico authenticator USB or a Yubico authenticator app.

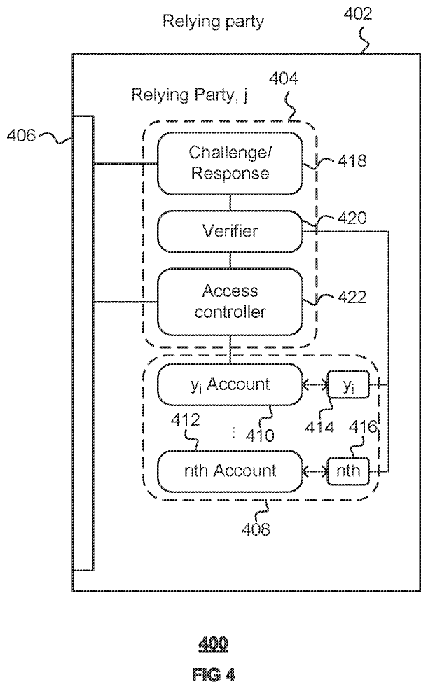

The communication interface 106 supports communications with other authenticators. The communication interface 106 also supports communications with a relying party (described below with reference to FIG. 4). Throughout the application the term relying party should be interpreted as a relying party device or system.

Throughout the application, references to communications and communicating with another entity such as, for example, an authenticator, a replying party or any other device, comprises both direct and indirect communications. Such indirect communications can be via an intermediary device or system or via a number of intermediary devices or systems. For example, any authenticator described herein could be a USB or other device that plugs into an intermediary to communicate with another entity such as another authenticator, relying party or any other device. Such an intermediary device or system, or intermediary devices or systems, can comprise a laptop, a tablet, a desktop, a smart phone, an electronic wearable device or any other computing device or system.

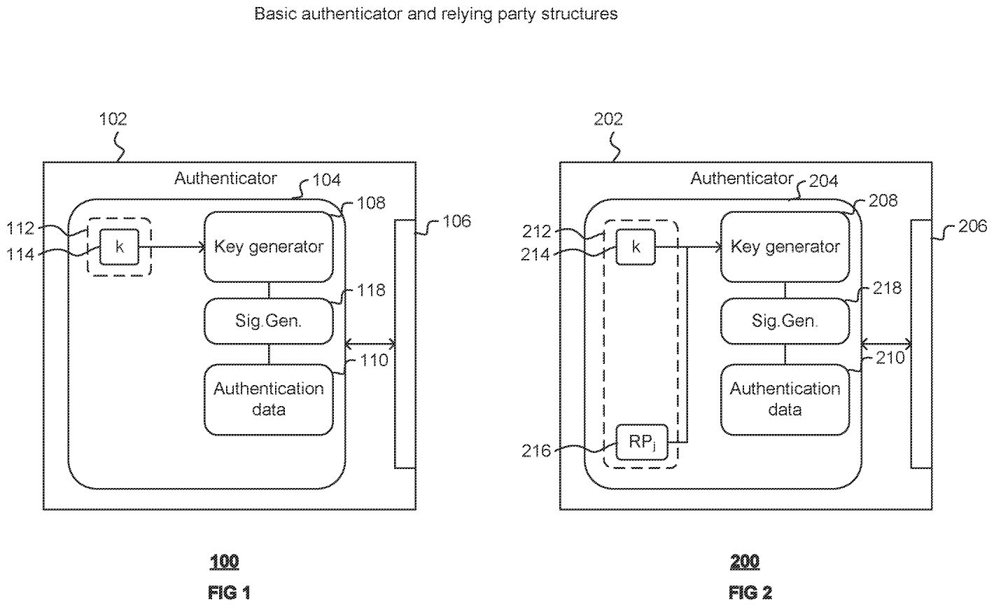

Referring to FIG. 2, there is shown a view 200 of an authenticator 202 according to an example implementation. The authenticator 202 comprises a processor 204. The authenticator 202 also comprises a communication interface 206. The communication interface supports communications with other authenticators and a set of relying parties. The set of relying parties may contain or relate to a single relying party or a plurality of relying parties.

The processor 204 comprises a key generator 208 or other authentication data generator. The key generator is associated with generating authentication data 210. The key generator 208 is responsive to seed data 212. Examples can be realised in which the seed data 210 comprises data from a plurality of sources. Examples can be realised in which the seed data 210 comprises a shared secret 214. The secret is shared amongst, generated by or is otherwise accessible, to a set of authenticators such as authenticator 202. The seed data 212 also comprises relying party data 216. The relying party data 216 is unique to, or uniquely associated with, a relying party described below with reference to FIG. 4. The relying party has, or provides, access to a resource that can be made available to a device authenticated by or using the authenticator 202. The resource accessible, or useable, via the relying party can comprise, for example, an account such as an email account or any other account or resource such as, for example, a bank account.

The processor 204 can also be configured to implement a signature generator 218. The signature generator is, or can be, used to generate proof of possession of the authentication data 210. For example, examples can be realised in which the authentication data comprises private-public keys generated by the key generator 208 and in which the signature generator 218 is arranged to generate a signature to provide proof of possession of the private key of the private-public key pair.

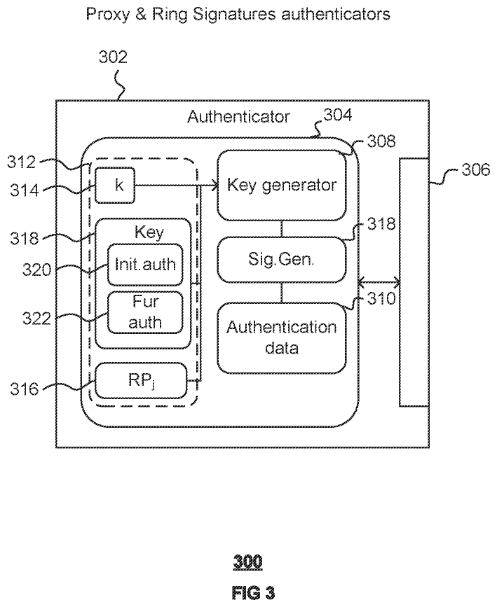

Referring to FIG. 3, there is shown a view 300 of an authenticator 302. The authenticator comprises a processor 304. The authenticator 302 also comprises a communication interface 306. The communication interface is arranged to support communications with other authenticators and a set of relying parties. The set of relying parties can comprise a single relying party or a number of relying parties. The processor 304 can be configured to implement a key generator 308 or other authentication data. The key generator 308 is arranged to produce authentication data 310. The authentication data 310 is used in an authentication process to gain access to a resource held by a relying party (not shown).

The key generator 308 is responsive to seed data 312. Examples can be realised in which the seed data comprises a shared secret 314. The shared secret can be generated by, or is otherwise accessible to, a set of authenticators (not shown) comprising the authenticator depicted 302. The seed data 302 may also comprise relying party data 316. The relying party data 316 is uniquely associated with a respective relying party. The relying party can be one of a set of relying parties. The set of relying parties can comprise a single relying party or a plurality of relying parties. Examples can be realised in which the seed data comprises further authentication data 318. The further authentication data 318 is associated with, or derived, from the set of authenticators (not shown). The set of authenticators can comprise one further authenticator or a plurality of further authenticators. In the example depicted in FIG. 3, the further authentication data 318 comprises private-public key pairs 320 and 322. An initial private-public key pair 320 is associated with the authenticator 302 depicted in FIG. 3. A further private-public key pair 322 is associated with a further authenticator (not shown). The relying party data 316 and the further public-private key pair 322, that is, the further authentication data, are received by, or otherwise accessible to, the authenticator 322, via the communication interface 306.

Throughout the description it will be appreciated that seed data can be realised as, or are examples of, source keying material.

Referring to FIG. 4, there is shown a view 400 of a relying party 402. The relying party 402 is an example of the abovementioned relying parties. The relying party comprises a processor 404. The relying party comprises a communications interface 406. The relying party 402 also comprises a set of resources 408. The set of resources 408 can comprise, for example, a user account or multiple user accounts such as the accounts 410 and 412 illustrated. The accounts are accessible using associated authentication data 414 and 416.

The processor 404 is configured to implement a challenge/response protocol 418. The challenge/response protocol 418 is arranged to issue challenges and associated relying party data (not shown) to authenticators such as any of the above described authenticators and to process the challenge responses received, via the communications interface 406, from the authenticators. The processor also comprises a verifier 420. The verifier is arranged to verify authentication data provided to the relying party 402 by an authenticator in response to a challenge issued under the challenge/response protocol. The verifier 420 determines whether or not the provided authentication data (not shown) is valid or invalid. The processor also comprises an access controller, or resource manager, 422 that is responsive to the output of the verifier 420 in granting or preventing access to the resources 408.

Throughout the following description, references will be made to authentication data associated with an authenticator of a set of authenticators and a relying party of a set of relying parties. The authentication data can comprise private-public authentication data. The private-public authentication data will be referred to in the figures using subscript indices in which the first index relates to a given authenticator to which the authentication data relates and in which the second index relates to the relying party to which the authentication data relates or with which the given authenticator is communicating or with which the given authenticator has communicated. For example, assuming an i^{th} authenticator of a set of authenticators is communicating with a j^{th} relying party of a set of relying parties, the authentication data associated with the i^{th} authenticator and the j^{th} relying party would be (xᵢⱼ,yᵢⱼ), where (xᵢⱼ,yᵢⱼ) represent private-public authentication data. For example, in a set of two authenticators, comprising an initial authenticator and a further authenticator, communicating with a j^{th} relying party, the authentication data relating to the initial and further authenticators would have private-public authentication data of (x₁ⱼ,y₁ⱼ) and (x₂ⱼ,y₂ⱼ). The j^{th} relying party would be the j^{th} relying party of a set of relying parties, which is also known as a specific relying party, as opposed to a single relying party if the set of relying parties comprised a single relying party. However, in the following, in the case of a single relying party, either the relying party reference or index will not be used or the relying party index will be the same for each authenticator in the set of authenticators. Also, however, in instances where the authentication data is not specific to a given authenticator, that is, in which the authentication data is shared between authenticators in the set of authenticators, either the authenticator indices will not be used or the authenticator indices for such common authentication data will be the same. Similarly, for examples in which the set of relying parties comprises one relying party.

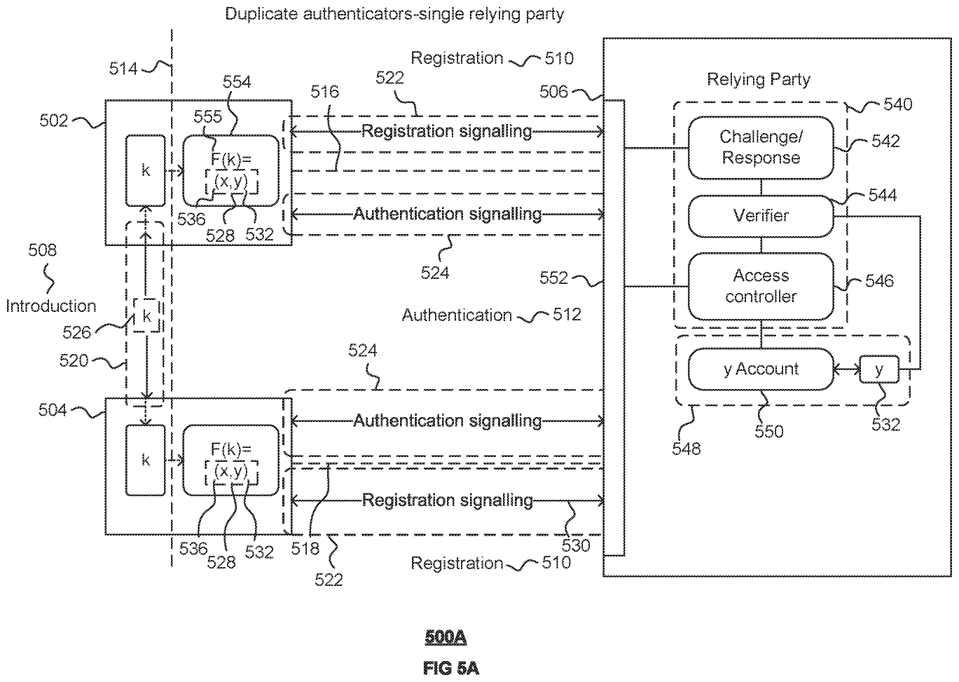

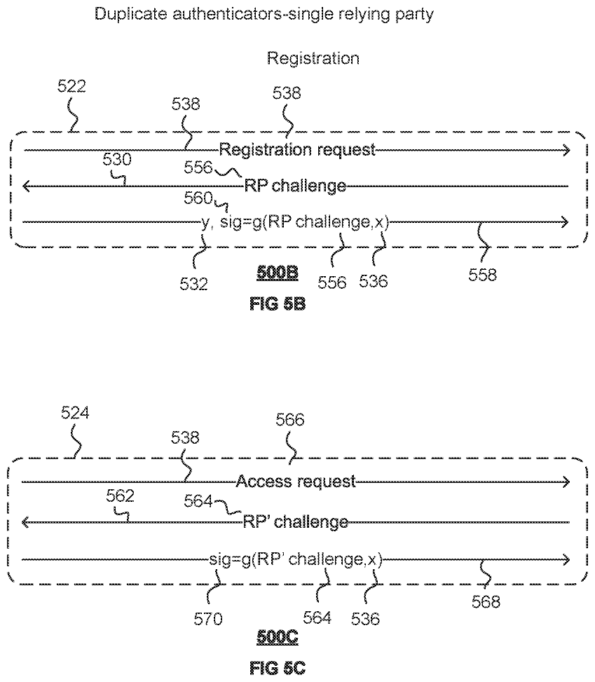

Referring to FIG. 5A, there is shown a view 500A of an authentication system. The authentication system comprises an initial authenticator 502, a further authenticator 504 and a relying party 506. The authenticator 502 is an example of an initial authenticator. The relying party 506 is an example of the above relying party 402. The relying party 506 can be a single relying party or can be one of a set of multiple relying parties.

The initial authenticator 504 and the further authenticator 504 form a set of authenticators comprising a number of authenticators. In the example depicted in FIG. 5, the set of authenticators comprises two authenticators; namely, the initial authenticator 502 and the further authenticator 504. However, examples are not limited to two authenticators per set. Examples can be realised in which the set of authenticators comprises n authenticators, where n≥2.

The initial authenticator 502, further authenticator 504 and relying party 506 are arranged to interact to realise an authentication system and method. The authentication method is an example of an authentication protocol. Examples can be realised that implement a multistage authentication method. The multistage authentication method can comprise three phases; namely an introduction or introductory phase 508, a registration phase 510, and an authentication phase 512. The three phases have been demarcated using regions that are respective sides of three dashed lines 514 to 518. Operations associated with the introductory phase 508 are shown to the left of an initial dashed line 514. Operations associated with the registration phase 510 are shown either above a further dashed line 516 or below a yet further dashed line 518. Operations associated with the authentication phase 512 are shown either below the further dashed line 516 or above the yet further dashed line 518. Examples can be realised in which one of the registration phases is operative for a given set of authenticators according to which authenticator in the set of authenticators performs the registration phase on behalf of the set of authenticators.

Each of the phases comprises respective signalling or communications between the authenticators and relying party. In the example shown, the introductory phase 508 comprises introductory signalling 520, the registration phase 510 comprises registration signalling 522 and the authentication phase 512 comprises authentication signalling 524.

The introductory signalling 520 comprises establishing seed data 526 for the authenticators in a set of authenticators. The seed data 526 is an example of the above described seed data 112, 212, 312. The seed data 526 is used to determine authentication data 528 to be used in the registration and authentication phases. In the example shown, the seed data 526 comprises a secret that is common to the authenticators in the set of authenticators. The seed data or secret can be derived from the authenticators in the set of authenticators cooperating or can be issued by a dealer. Therefore, in the example shown, the secret 526 can be established by the authenticators 502, 504 cooperating or can be sent to the authenticators 502, 504 by a dealer. Rather than the secret being shared amongst all of the authenticators, the shared secret can be established on a pairwise basis such as, for example, between the initial authenticator and any other authenticator in the set of authenticators.

Either of the initial authenticator 502 or the further authenticator 504 can be, or are, configured to instigate or respond to interactions or communications with the relying party 506 during the registration phase 510. The registration signalling 522 comprises providing the relying party 506 with authentication data and proof of the validity or authenticity of the authentication data. The authentication data provided by an authenticator to the relying party can be used by any other authenticator in the set of authenticators to validly authenticate itself with the relying party 506.

Examples can be realised in which the relying party 506 issues a challenge 530, known as an initial relying party challenge, to the initial authenticator 502. In response to receiving the challenge 530, the initial authenticator 502 provides at least a portion 532 of the authentication data 528 to the relying part 506 that can be used by the further authenticator 504 in authenticating the further authenticator 506 to the relying party 506. The initial authenticator 502 also provides proof 536 of the authenticity of the provided authentication data to the relying party 506. In the example depicted, the proof of the authentication data can comprise a signature that provides proof of the authenticity of the provided authentication data. Examples can be realised in which the signature comprises data signed by the initial authenticator using a further portion 536 of the authentication data 528. The data signed by the initial authenticator can comprise the challenge 530, or data derived from the challenge 530 such that the signature comprises the challenge 530 signed using the further portion 536 of the authentication data. Examples can be realised in which the authentication data 528 comprises a private-public key pair having a public key 532 and a private key 536. Therefore, the portion of authentication data 528 provided by the initial authenticator comprises the public key, and the further portion of the authentication data comprise the private key 536.

Examples can be realised in which the registration signalling 522 comprises an initial communication 538 between the initial authenticator 502 and the relying party 506 that precedes the relying party challenge 530, or that causes the relying party 506 to issue the challenge 530. The initial communication 538 can be instigated by the initial authenticator 502 or the relying party 506.

The relying party 506 comprises a processor 540 that is configured to implement a challenge/response protocol 542, a verifier 544, and an access controller 546. The access controller 546 controls access to a resource 548. The authentication data 532 provided to the relying party can be associated with the resource 548 subject to verification by the verifier 544. The challenge/response protocol 542 is an example of the above described challenge/response protocol 418. The verifier 544 is an example of the above described verifier 420. The access controller 546 is an example of the above described access/resource controller 422. The resource 548 can comprise, for example, a bank account, an email account, hardware resource, software resource, a virtual machine, virtual machine resources, or the like. The examples described herein will use an account 550 as the resource such as the bank account or the email account. The account 550 is an example of the above accounts 410, 412 and the authentication data 532 is an example of the above authentication data 414, 416. The relying party 506 comprises a communication interface 552. The communication interface is an example of the above described communication interface 406.

The initial authenticator 502 comprises a processor 554. The processor 554 is an example of the above described processors 104, 204, 304. The processor 554 is configured to generate the authentication data 528 via a respective process or function 555. The respective process or function 555 can be realised using key derivation functions as described below. In the example depicted, the authentication data can be a function of the seed data such as, for example, the secret key 526, that is, the authentication data is generated using or is otherwise related to, or derived from, the secret.

Referring to FIGS. 5A and 5B, an example of the registration signalling 522 will be described with reference to the authentication data 528 being the private-public key pair 532, 536.

The relying party 506 issues a relying party (RP) challenge 530 to the authenticator 502. The RP challenge 530 comprises RP challenge data 556. The RP challenge data 556 can vary and is specific to a RP communication. The RP challenge data 556 can vary per session such as, for example, per registration session, authentication session or any other session. Examples can be realised in which the challenge data comprises a randomly generated string, alphanumeric data, the time, a counter value or any other data. The authenticator 502 uses the secret 526 to generate the private-public key pair 528. In response to the relying party challenge 530, the initial authenticator 502 outputs a challenge response 558 to the relying party 506. The challenge response 558 comprises authentication data and proof of the veracity of the authentication data. In the example shown, the authentication data comprises the public key 532 of the public-private key pair 528 and the proof of the veracity of the authentication data comprises a signature 560. Examples can be realised in which the signature is derived from the RP challenge 530 and the private key 536. Examples can be realised in which the signature comprises the RP challenge 530 signed using the private key 536.

In response to receiving the communication from the initial authenticator 502 following the relying party challenge 530, the verifier 544 verifies the signature 560. The verifier 544 determines whether or not the proof of possession of the private key 536 is valid or invalid. If the verifier 544 determines that the signature is invalid, processing terminates. Terminating processing can take the form of access to the resources being denied. The denial can be with or without an output message (not shown) to that effect being transmitted to the initial authenticator 502. However, if the verifier 544 determines that the signature 560 is valid, an indication to that effect is passed to the resource/access controller 546. In response to receiving an indication that the signature 560 has been verified as valid, the access controller 546 associates resources 548 with the received authentication data 532. Examples can be realised in which the access controller 546 creates the account 550 and associates that account with the received authentication data 532.

The RP challenge 530 may be instigated in response to an event. The event can be, for example, a request to register the set of authenticators with the relying party 506 to gain access to resources managed by, or accessible via, the relying party 506.

Referring FIGS. 5A and 5C, the authentication signalling 524 between the further authenticator 504 and the relying party 506 will be described in greater detail. The authentication signalling 524 allows the further authenticator 504 to access the resources 548 even though the further authenticator 504 has not registered with the relying party 506, which follows from the initial authenticator 502 having forwarded to the relying party 506 authentication data relating to, or useable by, the further authenticator 504.

The relying party 506 can issue a relying party further challenge 562 to the further authenticator 504. The relying party further challenge 562 comprises relying party further challenge data 564. The relying party further challenge 562 is unique for a given session or phase or is otherwise specific to the relying party 506 for a given session or phase. Examples can be realised in which the relying party further challenge 562 is unique to the authentication session or phase. The relying party further challenge 562 can be issued in response to an event. The event can comprise, for example, a communication 566 instigated by the further authenticator 504, the relying party 506 or some other entity (not shown). For example, the relying party further challenge 562 can be issued in response to the further authenticator 504 sending an access request 566 to the relying party 506 requesting access the resource 548 such as the account 550. The relying party further challenge 562 is different to the above described relying party challenge issued to the initial authenticator 502.

Throughout the examples described herein, having different relying party challenges or different relying party further challenges helps counter or otherwise guards against an attacker acquiring a previously signed repeated challenge to gain access to the resources.

The further authenticator 504 also has access to the shared secret 524 and also implements the same authentication data generation function or process as the initial authenticator 502. Therefore, the further authenticator 504 produces the same authentication data 528, in response to the seed data, as that produced by the initial authenticator 502. In particular, in the example shown in FIGS. 5A and 5C, the authentication data 528 comprises an instance of the same private-public key pair 532, 536 as mentioned above in respect of the initial authenticator 502.

In response to the relying party further challenge 562, the further authenticator 504 outputs a challenge response 568 to the relying party 506. The challenge response 568 comprises proof of the veracity of the authentication data. In the example shown, the proof of the veracity of the authentication data comprises a signature 570. Examples can be realised in which the signature 570 is derived from the authentication data 528. Examples can be realised in which the signature 570 is derived from the relying party further challenge data 564 and the private key 536. Examples can be realised in which the signature 570 is the relying party further challenge data 564 that has been signed using the private key 536.

In response to receiving the communication 568 from the further authenticator 504 following the relying party further challenge 562, the verifier 544 verifies the signature 570. The verifier 544 determines whether or not the proof of possession of the authentication data such as, for example, proof of possession of the private key 536, is valid or invalid. Verifying whether or not the proof of possession of the authentication is valid can comprise determining whether or not the signature 570 is valid. If the verifier 544 determines that the proof of possession of the authentication data such as, for example, the signature 570, is invalid, processing terminates. Terminating processing can take the form of access to the resources being denied. The denial can be with or without an output message (not shown) to that effect being transmitted to the further authenticator 504. However, if the verifier 544 determines that the proof of possession of the authentication data is valid, an indication to that effect is passed to the resource/access controller 546. In response to receiving an indication that the signature 570, or other authentication data, has been verified as valid, the access controller 546 provides the further authenticator 504 with access to the resource 548. For example, in the example shown, the access controller 546 can provide the further authenticator 504 with access to the account 550.

Therefore, creating and providing access to a commonly accessible resource to multiple authenticators can be realised even when a user has access to a subset of those authenticators and, in particular, even if a user has access to a single authenticator such as the above described initial authenticator 502. This is achievable because the initial authenticator 502 generates or provides the relying party 506 with authentication data relating to with the further authenticator. In the example depicted and described with reference to FIGS. 5A-C, the authentication data sent to the relying party 506, by the initial authenticator 502, is authentication data such as, for example, the public key 532, associated with the further authenticator 504. Examples can be realised in which that authentication data is generated using a secret associated with the set of authentications. In the example depicted in FIGS. 5A-C, the set of authenticators comprises the initial authenticator 502 and the further authenticator 504. However, the set of authenticators could comprise n authenticators, where n≥2.

Although the initial authenticator 502 has been described as the authenticator that registered authentication data on behalf of the set of authenticators with the relying party 506, examples are not limited to such an arrangement. It can be appreciated from FIGS. 5A-C that the further authenticator 504 could, equally well, perform the processing undertaken by the initial authenticator 502 and vice-a-versa. Consequently, examples can be realised in which the initial relying party challenge 530 is sent to the further authenticator 504 and in which the further authenticator 504 provides, in response to the challenge, the authentication data 528 together with proof of possession of the private authentication data 536. As indicated above, that proof can take the form of a signature 560 derived from the relying party challenge 530 signed with the private authentication data such as, for example, a private key 536.

Although the example shown in FIGS. 5A-C depict a resource 548 or an account 550, examples are not limited to such an arrangement. Examples can be implemented in which multiple resources, multiple accounts or a combination of multiple resources and multiple accounts are provided. The multiple resources or multiple accounts may be associated with authenticators of the set of authenticators or with a further set of authenticators.

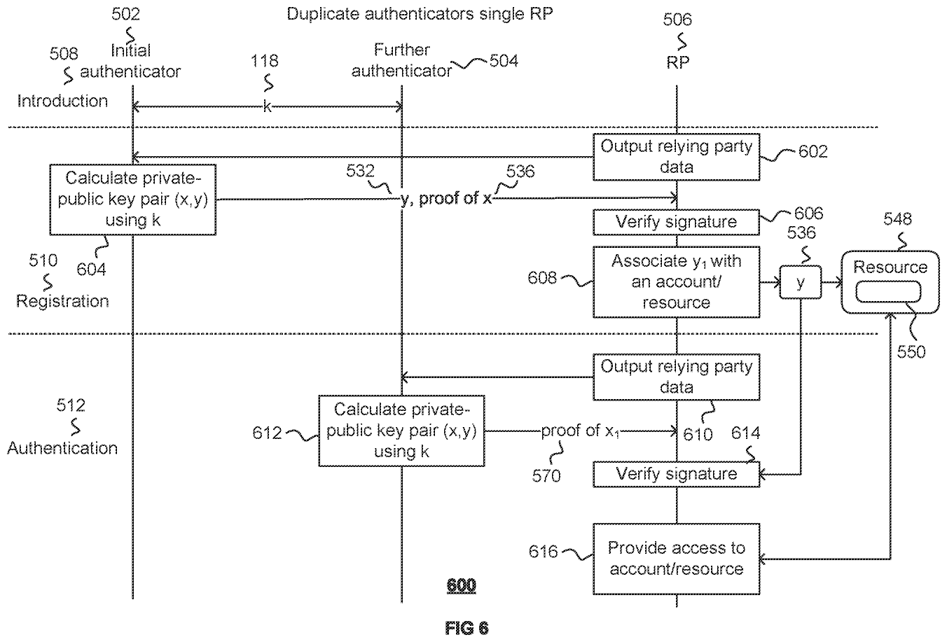

Referring to FIG. 6, there is shown a view 600 of the signalling and operations or processing performed by the authentication system shown in, and described with reference to, FIGS. 5A-C. Reference numerals common to FIGS. 5A-C and FIG. 6 refers to the same elements.

The view 600 shows the three phases; namely, the introductory phase 508, the registration phase 510 and the authentication phase 512.

Referring to the introductory phase 508, the initial and further authenticators 502, 504 establish or access shared seed data. In the example depicted, the shared seed data is the shared secret 526.

Referring to the registration phase 510, the relying party 506 creates and outputs, at 602, the relying party challenge 530 to the initial authenticator 502. In response, the initial authenticator 502 creates and outputs, at 604, the public portion 532 of the authentication data and proof of possession of the private portion 536 of the authentication data to the relying party 506. The proof of possession of the private portion 536 comprises, in the example depicted, the signature 560. The relying party 506 verifies the proof of possession of the private portion 536 of the authentication data, such as the signature 560, at 606, to determine if the proof or signature is valid or invalid. If the proof of possession of the private portion 536 of the authentication data is valid, the relying party 506 can conclude that the initial authenticator 502 is valid or genuine and can associate, at 608, the resources 548 with the public portion 532 of the authentication data. In the example depicted in FIG. 6, associating resources with the public portion 532 comprises associating the account 550 with the public authentication data.

Referring to the authentication phase 512, the relying party 506 creates and outputs, at 610, the relying party further challenge 562. The further authenticator 504 processes the relying party further challenge 562 and outputs, at 612, proof of possession of the private portion 536 of the authentication data. The proof 570 of possession of the private portion 536 comprises, in the example depicted, the signature 570. The relying party 506 processes the proof 570 of possession of the private portion 536 of the authentication data, such as the signature 560, at 614, to determine if the proof or signature 570 is valid or invalid. If the proof 570 of possession of the private portion 536 of the authentication data is valid, the relying party 506 can conclude that the further authenticator 504 is valid or genuine and can provide, at 616, access to the resources 548 associated with the public portion 532 of the authentication data. In the example depicted in FIG. 6, providing access to the resources 548 associated with the public portion 536 comprises providing access the further authenticator 504 with access to the account 550.

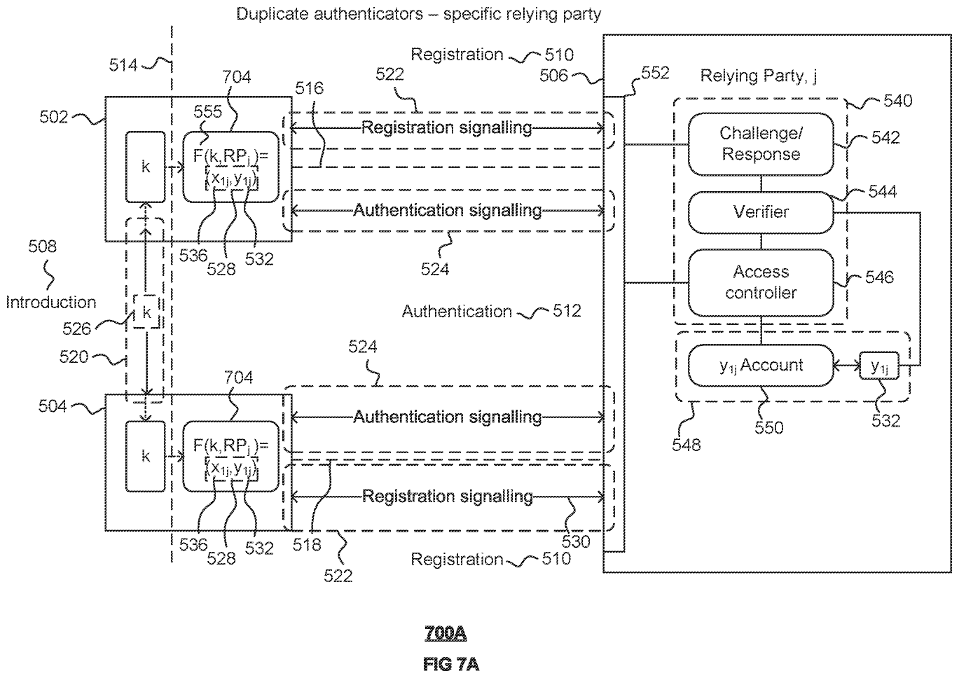

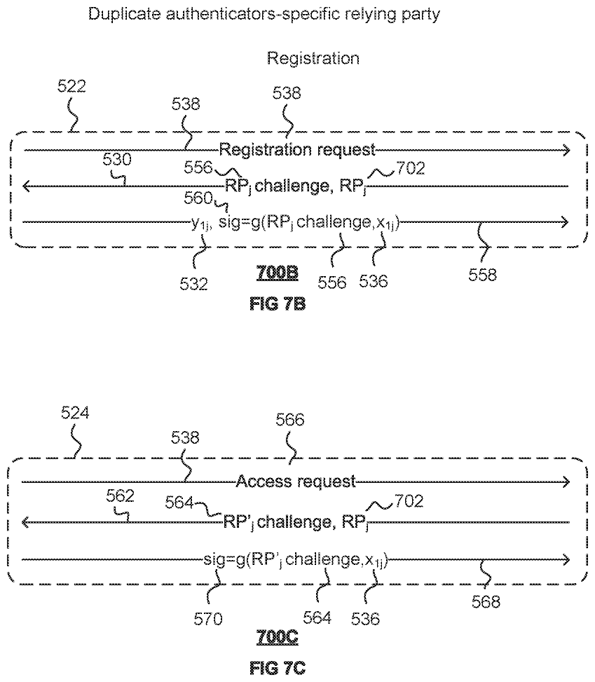

Referring to FIGS. 7A-C, there is shown a view 700A in FIG. 7A of an authentication system together with respective signalling in FIGS. 7B and 7C. Reference numerals that are common to FIGS. 5A-C and 7A-C refer to the same elements.

The authentication system comprises an initial authenticator 502, a further authenticator 504 and a relying party 506. The relying party 506 is a specific relying party that is one of a set of relying parties with which the initial authenticator 502, the further authenticator 504 or both the initial and further authenticators 502, 504 can interact. The set of relying parties is not shown, but can comprise a number, m, of relying parties where m≥1.

Differences between the authentication system shown in, and described with reference to, FIGS. 7A-C and the authentication system shown in, and described with reference to, FIGS. 5A-C will now be described.

Referring to FIG. 7B, the specific relying party 506 is arranged to provide specific relying party data 702 that uniquely identifies the relying party to an authenticator with which it interacts or otherwise communicates. The specific relying party data 702 can be provided to an authenticator either alone or together with a respective challenge. The challenge can be any challenge such as, for example, the challenge 530 issued during the registration phase 510, the authentication phase 512 or both the registration 510 and authentication 512 phases. Therefore, in the example depicted, the specific relying party data 702 can be provided to the initial authenticator 502 together with the challenge 530 issued by the specific relying party 506. Similarly, the specific relying party data 702 can be provided to the further authenticator 504 together with the challenge 562 issued by the specific relying party 506. Examples can be realised in which the specific relying party data 702 can be provided to both the initial 502 and further 504 authenticators together with respective challenges 530, 562.

In response to receiving the challenge 530 and the specific relying party data 702, the initial authenticator 502 generates respective authentication data 528 using a respective function 704. The function 704 is similar to the above described function 554. However, the function 704 uses a number of parameters to determine the authentication data 528. In the example shown, the parameters, or seed data, can comprise the secret and the relying party specific data Deriving the authentication data 528 using the function 704 is such that the resulting authentication data 528 is unique to a given relying party. Having authentication data 528 that is unique to, a given relying party mitigates against privacy vulnerabilities. For example, such unique authentication data prevents adverse relying parties from collaborating to track the activity of a given authenticator by tracking public authentication data associated with that authenticator. Therefore, in the example shown, the authentication data 528 is unique to the specific relying party 506. Examples can, therefore, be realised in which the public portion 532 and the private portion 536 of the authentication data 528 are unique to the specific relying party 506.

Referring to FIG. 7C, again in response to receiving the challenge 562 and the specific relying party data 702, the further authenticator 504 generates respective authentication data 528 using the respective function 704 (or authentication data derivation process such as a private-public key derivation process). All further processing is as described above with reference to FIGS. 5A-C

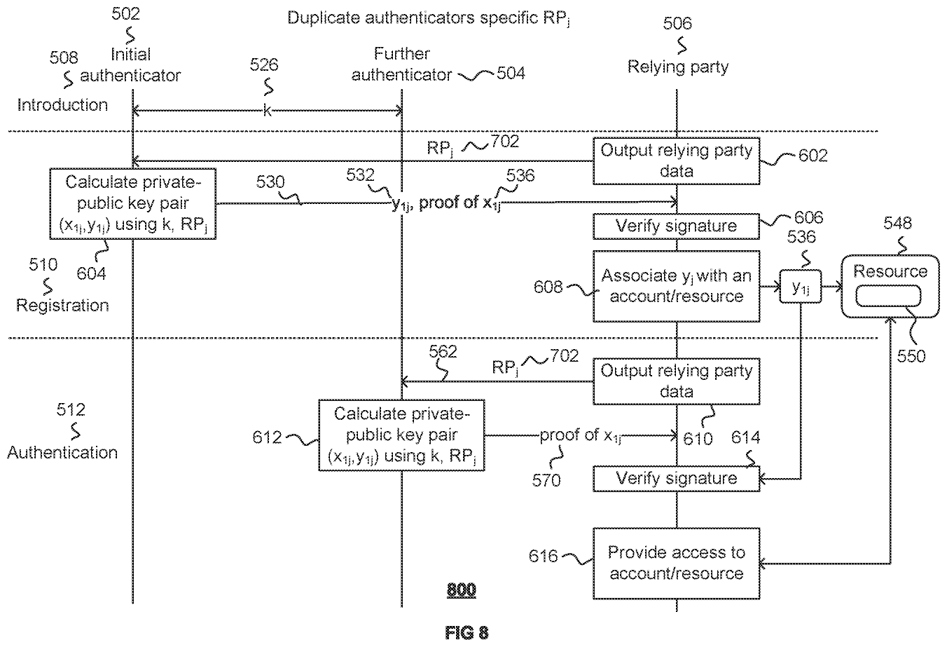

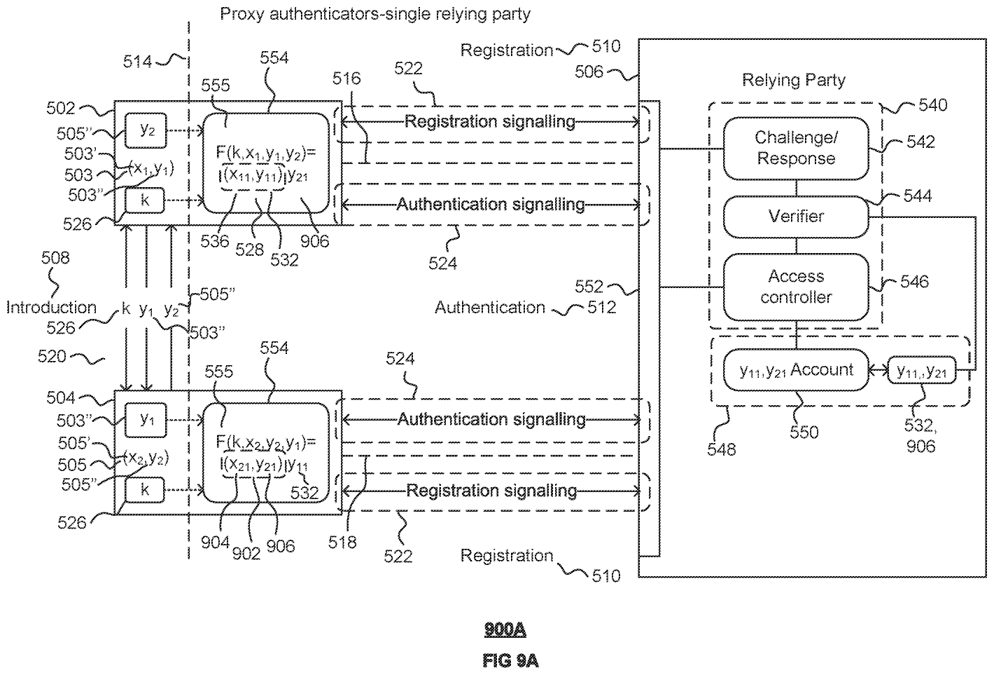

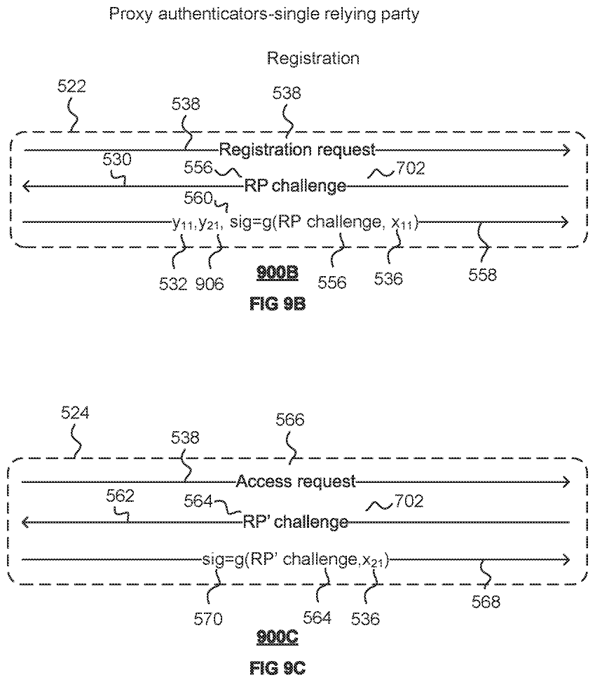

Referring to FIG. 8, there is shown a view 800 of the signalling and processing performed by the authentication system shown in, and described with reference to, FIG. 6. Reference numerals common to FIG. 6 and FIG. 8 refers to the same elements, subject to the differences described below.

The data, output at 602, to the initial authenticator 502 comprises the above described specific relying party data 702. In the example shown, the specific relying party data 702 can be output with or without the respective challenge 530 to the initial authenticator 502. Accordingly, the private-public key pair 528, that is, the authentication data, generated during the registration phase 510 will be uniquely associated with the specific relying party 506.

Therefore, the authentication data 528 generated, at 604, by the initial authenticator 502 is a function of both the seed data and the specific relying party data 702. In the example shown, the authentication data 528 comprises a private-public key pair 532, 536, derived from the shared secret 526 and the specific relying party data 702, that is unique to the specific relying party 506. The verification, at 606, and allocation of resources, at 608, take place as described above in FIG. 6.

Similarly, the data, output at 610, to the further authenticator 504 comprises the above described specific relying party data 702. In the example shown and described above, the specific relying party data 702 can be output with or without the respective challenge 562 issued to the further authenticator 504. Accordingly, the private-public key pair 528, that is, the authentication data, generated, at 612, during the authentication phase 512 will be uniquely associated with the specific relying party 506. The verification, at 614, and accessing resources, at 616, take place as described above in FIG. 6.

Therefore, creating and providing access to a commonly accessible resource to multiple authenticators can be realised even when a user has access to a subset of those authenticators and, in particular, even if a user has access to a single authenticator such as the above described initial authenticator 502. This is achievable because the initial authenticator 502 generates or provides to the relying party 506 authentication data relating to or otherwise associated with the further authenticator.

Although the initial authenticator 502 has been described as the authenticator that registers authentication data on behalf of itself and the further authenticator 504 with the relying party 506, examples are not limited to such an arrangement. It can be appreciated from FIG. 7A that the further authenticator 504 could, equally well, perform the processing undertaken by the initial authenticator 502 and vice-a-versa. Consequently, examples can be realised in which the initial relying party challenge 530 is sent to the further authenticator 504 and in which the further authenticator 504 provides, in response to the challenge, the authentication data 528 together with proof 536 of possession of the private authentication data 534. As indicated above that proof can take the form of a signature derived from the relying party challenge 562 having been signed with the private authentication data such as, for example, a private key 536.

Referring to FIG. 9A, there is shown a view 900A of an authenticator system that is substantially similar to the above authentication systems described with reference to, or as shown in, either of FIGS. 5A and 7A. Reference numerals common to FIGS. 5A, 7A and 9A refer to the same elements and the above descriptions of FIGS. 5A and 7A equally apply to FIG. 9.

The differences between FIGS. 9A and 5A, 7A will be described.

The initial authenticator 502 is arranged to generate initial authenticator further authentication data 503. In the example depicted, the initial authenticator further authentication data 503 comprises a private-public key pair comprising a private key 503′ and a public key 503″.

The further authenticator 504 is arranged to generate further authenticator further authentication data 505. In the example depicted, the further authenticator further authentication data 505 comprises a private-public key pair comprising a private key 505′ and a public key 505″.

The further authenticator 504 is arranged to generate further authentication data 902. The further authentication data 902 is generated using the seed data. In the example depicted, the seed data comprises the shared secret 526, and the initial authenticator further authentication data 503 and the further authenticator further authentication data 505. In the example illustrated, the seed data comprises the shared secret 526, and the public authentication data 503″ of the initial authenticator further authentication data 503 and public authentication data 505″ of the further authenticator further authentication data. The further authentication data 902 comprises private 904 and public 906 portions. In the example depicted, the further authentication data 902 is a private-public key pair in which the private key forms the private portion 904 and the public key forms the public portion 906.

During the introductory phase 508, the initial authenticator 502 receives the public portion 505″ of the authentication data 505 from the further authenticator 504, and generates the initial authenticator further authentication data 503. In the example shown, the private-public key pair is realised as a private-public key pair 503. Similarly, the further authenticator 504 generates the private-public authentication data 505. The private-public authentication data takes the form of a private-public key pair in the example depicted.

The initial authenticator 502 derives the further authentication data 528 and 906 from the seed data. In the example depicted, the seed data comprises the secret, the further authenticator further authentication data 503, and the public authentication data 505″ of the further authenticator further authentication data 505.

During the registration phase 510, in addition to sending the relying party 506 the public portion 532 of the authentication data 528, the initial authenticator 502 also sends the relying party 506 the public portion 906 of the further authentication data 902. In response to receiving the public authentication data 532 and 906 associated with the initial 502 and further 504 authenticators, following a valid verification of the proof of possession of the private portion 536 of the authentication data 528, the relying party 506 associates the resources 548 with the two public portions 532, 906. In the example shown, in response to receiving the two public keys 532, 906, the relying party 506 associates the resources 548 with both of the public keys 532, 906.

Therefore, the initial authenticator 502 nominates the further authenticator 504 as a proxy for accessing the resources 548, which renders the resources 548 commonly accessible to both the initial authenticator 502 and the further authenticator 504, even though only one authenticator 502 registered with the relying party 506.

The converse of the above also applies in which the further authenticator nominates the initial authenticator as a proxy. In such an example, during the introductory phase 508, the further authenticator 504 receives the public portion 503″ of the initial authenticator further authentication data 503 from the initial authenticator 502.

During the registration phase 510, in addition to sending the relying party 506 the public portion 906 of the authentication data 902, the further authenticator 504 also sends the relying party 506 the public portion 532 of the further authentication data 528. Again, in response to receiving the public authentication data 532 and 906 associated with the initial 502 and further 504 authenticators, following a valid verification of the proof of possession of the private portion 904 of the authentication data 902, the relying party 506 associates the resources 548 with the two public portions 532, 906. In the example shown, in response to receiving the two public keys 532, 906, the relying party 506 associates the resources 548 with both of the public keys 532, 906.

Therefore, the further authenticator 504 nominates the initial authenticator 502 as a proxy for accessing the resources 548, which renders the resources 548 commonly accessible to both the initial authenticator 502 and the further authenticator 504, even though only one authenticator 504 registered with the relying party 506.

To support either of the initial 502 and further 504 authenticators instigating communications with the relying party 506, or to support either of the initial 502 and further authenticators 504 responding to relying party challenges, examples can be realised in which the pubic authentication data 503″ and 505″ is exchanged between the initial 502 and further authenticators 504. In examples in which the set of authenticators comprises n authenticators, any given authenticator receives from the other (n−1) authenticators respective public portions of respective authentication data of the other (n−1) authenticators to support the given or receiving authenticator in nominating the other (n−1) authenticators as proxies using those respective public portions of the respective authentication data.

Referring to FIGS. 9A and 9B, an example of the registration signalling 522 will be described. The registration signalling is substantially similar to the above registration signalling described with reference to FIGS. 5B,5C and 7B,7C. Reference numerals common to FIGS. 5B,5C, 7B,7C and FIGS. 9B, 9C refer to the same elements and the above descriptions of FIGS. 5B,5C and 7B,7C apply equally to FIGS. 9B, 9C.

The differences between FIG. 9B and FIGS. 5B, 7B will be described.

During the registration signalling 522, in response to receiving the relying party challenge 530, the initial authenticator 502 responds by sending the relying party 506 public authentication data 532, 906 relating to all authenticators in the set of authenticators, which nominates all other authenticators in the set of authenticators as proxies for the initial authenticator 502. In the example shown, the set of authenticators comprises the initial authenticator 502 and the further authenticator 504. Therefore, in response to the relying party challenge 530, the initial authenticator 502 sends the public keys 532, 906 to the relying party 506.

It can be seen that the signalling associated with the authentication phase 524 remains unchanged relating to the above but for the proof of possession of the corresponding private portion of the authentication data comprising the private portion 904 of the further authentication data 906

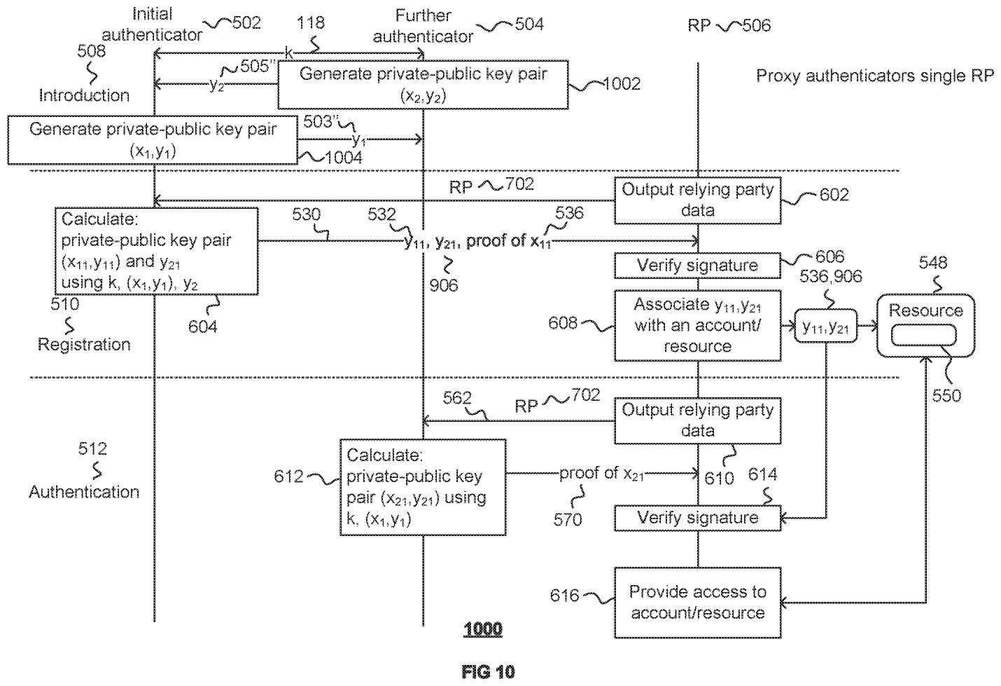

Referring to FIG. 10, there is shown a view 1000 of the signalling and processing performed by the authentication system shown in, and described with reference to, FIGS. 9A-C. Reference numerals common to FIGS. 6, 9A-C, and FIG. 10 refers to the same elements. Therefore, the differences between FIG. 10 and FIGS. 6, 9A-C will be described.

Since examples can be realised in which a given authenticator nominates other authenticators in a set of authenticators to act as proxies, the given authenticator receives the public portions of the authentication data associated with the other authenticators in the set of authenticators.

Therefore, during the introductory phase 508, the further authenticator 504 calculates, at 1002, the further authentication data 902 and outputs the public portion 906 to the initial authenticator 502. Examples can be realised in which all authenticators in a set of authenticators exchange public authentication data. Accordingly, examples can be realised in which the initial authenticator 502 calculates and outputs, at 1004, public authentication data 532 associated with the initial authenticator 502. In the example depicted, the public authentication data 532 associated with the initial authenticator 502 comprise the public key of a private-public key pair.

Referring to the registration phase 510, in response to receiving the relying party challenge, the initial authenticator 502 creates and outputs, at 602, to the relying party 506 the public portion 532 of the authentication data 528, the public portion 906 of the further authentication data 902 associated with the further authenticator 504 and proof of possession of the private portion 536 of the authentication data associated with the initial authenticator 502.

The relying party 506 processes the proof of possession of the private portion 536 of the authentication data, at 606, to determine if the proof or signature is valid or invalid. If the proof of possession of the private portion 536 of the authentication data is valid, the relying party 506 can conclude that the initial authenticator 502 is valid or genuine and can associate, at 608, the resources 548 with the public portions 532, 906 of authentication data of the initial authenticator 502 and the further authenticator 504 respectively. In the example depicted in FIG. 10, associating resources with the public portions 536, 906 comprises associating the account 550 with the public portions 536, 906.

Referring to the authentication phase 512, in response to the relying party further challenge 562, the further authenticator generates and outputs, at 612, proof of possession of the private portion 904 of the further authentication data 902 associated with the further authenticator 504. The proof of possession of the private portion 904 comprises, in the example depicted, the signature 570. The private portion 904 is used to generate the signature 570. Having verified, at 614, proof of possession of the private portion 904 as valid, the resource 548 is made available, at 616, to the further authenticator 504.

Therefore, the further authenticator 504 has been given access to the resources due to the introductory phase of sending, exchanging or obtaining public authentication data between authenticators in a set of authenticators.

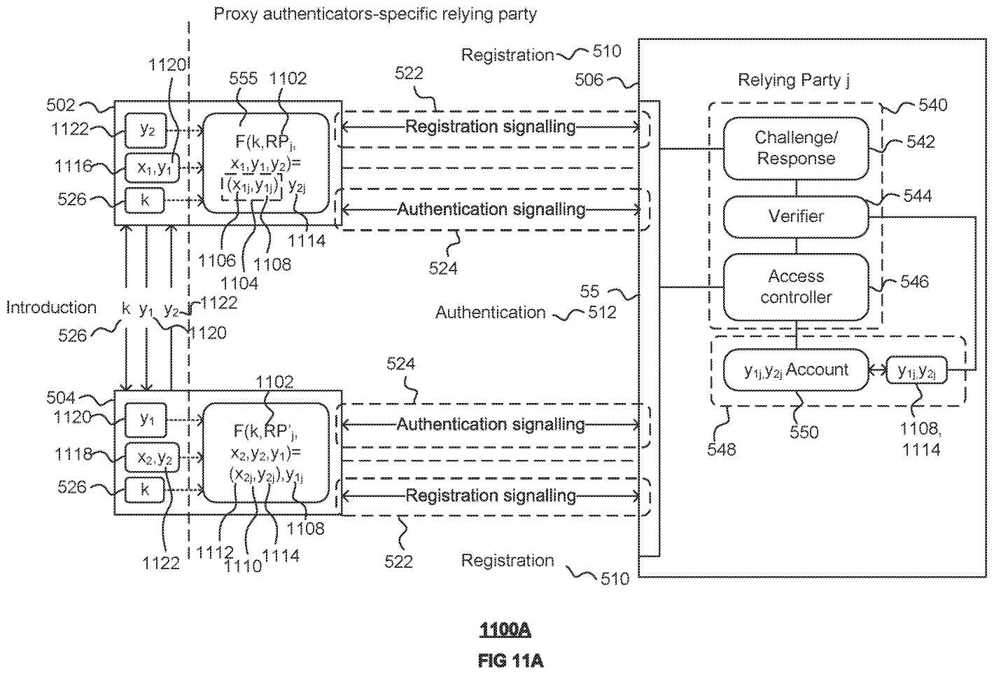

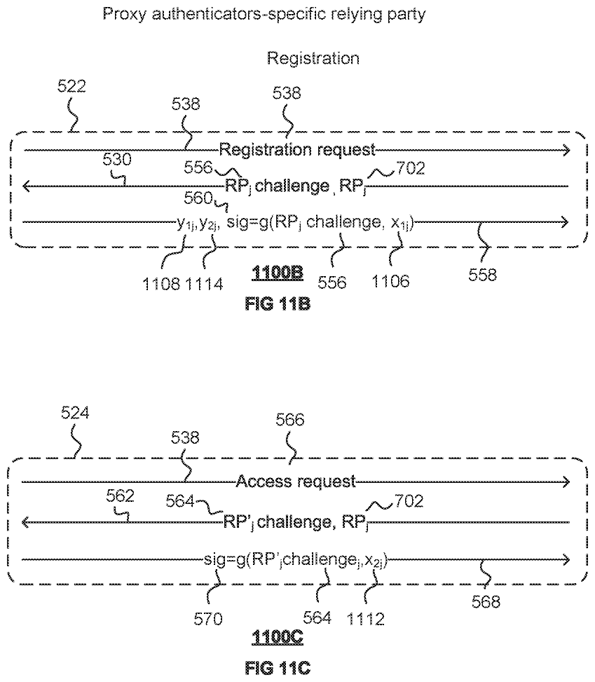

Referring to FIG. 11A there is shown a view 1100A of an authenticator system that is substantially similar to the above authentication systems described with reference to, and as shown in, any of FIG. 5A, 7A or 9A. Reference numerals common to FIGS. 5A, 7A, 9A, and 11A refer to the same elements and the above descriptions of FIGS. 5A, 7A and 9A equally apply to FIG. 11A.

The differences between FIG. 11A and FIGS. 5A, 7A and 9A will be described.

The authentication system comprises an initial authenticator 502, a further authenticator 504 and a relying party 506. The relying party 506 is a specific relying party that is one of a set of relying parties with which the initial authenticator 502, the further authenticator 504 or both the initial and further authenticators 502, 504 can interact. The set of relying parties is not shown

The authentication system operation and signalling with be described with reference to FIGS. 11A-C.

Referring to FIGS. 11A and 11B, in response to receiving the specific relying party data 702 that uniquely identifies the relying party 506 to an authenticator with which the relying party 506 interacts or otherwise communicates, the initial authenticator 502 generates respective authentication data using a respective function 1102, the specific relying party data 702, the secret 526 and authenticator specific private-public authentication data associated with the initial authenticator and public authentication data associated with the further authenticator. The function 1102 is similar to the above described functions 555 and 704. The function is used to derive private-public and public authentication data 1104, 1114 that is unique to the relying party 506 and that is associated with the initial authenticator 502 and the further authenticator 504. The private-public authentication data 1104, 1114 comprises, in the example shown, a private-public key pair comprising a private key 1106 and a public key 1108 and a public key 114 associated with the further authenticator.

Similarly, in response to receiving the specific relying party data 702 that uniquely identifies the relying party 506 to an authenticator with which the relying party 506 interacts or otherwise communicates, the further authenticator 504 can generate respective authentication data using the respective function 1102, the specific relying party data 702, the secret 526 and authenticator specific and private-public authentication data associated with the further authenticator and public authentication data associated with the initial authenticator. The function 1102 is similar to the above described functions 555 and 704. The function is used to derive private-public and public authentication data 1110, 1108 that is unique to the relying party 506 and that is associated with the further authenticator 504 and the initial authenticator 502 using the specific relying party data 702 and the secret 526. The private-public authentication data 1110, 1114 comprises, in the example shown, a private-public key pair comprising a private key 1112 and a public key 1114 and public authentication data 1108 associated with the initial authenticator.

The initial 502 and further 504 authenticators also generate respective long term or authenticator specific authentication data 1116 and 1118 respectively. Each instance of authenticator specific authenticator data comprises respective private and public portions. In the example shown, the initial authenticator specific authentication data 1116 comprises a respective private-public key pair and the further authenticator specific authentication data 1118 comprises a respective private-public key pair. The initial authenticator specific private-public key pair 1116 comprises a public key 1120. The further authenticator specific private-public key pair 1118 comprises a public key 1122

The authenticator specific public keys 1120, 1122 can be exchanged during the introductory phase 508. However, the example will be described with reference to the further authenticator 504 sending its authenticator specific public authentication data 1122 to the initial authenticator 502 to support the initial authenticator 502 nominating the further authenticator 504 as a proxy.

The relying-party-specific public authentication data 1104 associated with the initial authenticator 502 is derived from data comprising the initial authenticator specific authentication data 1116. The relying-party-specific public authentication data 1110 associated with the further authenticator 504 is derived from data comprising the further authenticator specific authentication data 1118.

The function 1102 at the initial authenticator 502 can also derive the rely-party-specific public authentication data 1114 associated with the further authenticator 504 using both the received further authenticator specific public authentication data 1122, the specific relying party data 702 and the secret 526.

Similarly, the function 1102 at the further authenticator 504 can also derive the rely-party-specific public authentication data 1108 associated with the initial authenticator 502 using both the received initial authenticator specific public authentication data 1120, the specific relying party data 702 and the secret 526.

The initial authenticator 502 is also arranged to generate proof of possession of the relying-party-specific private authentication data 1106. In the example shown, generating proof of possession of the relying-party-specific private authentication data 1106 comprises generating the signature 560 using the relying-party-specific private authentication data 1106 and the relying party challenge 556. Examples can be realised in which the signature comprises the specific relying party challenge 556 signed using the private authentication data 1106.

Similarly, the further authenticator 504 is also arranged to generate proof of possession of the relying-party-specific private authentication data 1112. In the example shown, generating proof of possession of the relying-party-specific private authentication data 1112 comprises generating the signature 570 using the relying-party-specific private authentication data 1112 and the specific relying party challenge data 564. Examples can be realised in which the signature 570 comprises the specific relying party challenge data 564 signed using the private authentication data 1112.

Having derived the relying-party-specific public authentication data 1108, 1114, the initial authenticator 502 sends that data 1108, 1114 to the relying party 506 together with the proof 560 of possession of the relying-party-specific private authentication data 1106.

Upon receiving the relying-party-specific public authentication data 1108, 1114 and the proof 560, the relying party 506 verifies the proof 560 as being valid or invalid using the verifier 544. In the event that the verification process fails, that is, the signature is found to be invalid, a communication (not shown) to that effect is sent to the initial authenticator 502. If the verification process succeeds, the relying party 506 creates or allocates resources 548 associated with the relying-party-specific public authentication data 1108, 1114.

Referring to FIG. 11C, again, in response to receiving the specific relying party challenge 562, comprising the specific relying party challenge data 564, and the specific relying party data 702, the further authenticator 504 generates proof 570 of possession respective relying-party-specific private authentication data 1112. The proof 570 of possession of the rely-party-specific private authentication data 1112 can be realised using the specific relying party further challenge 564 and the relying-party-specific private authentication data 1112. Examples can be realised in which the proof 570 is created by signing the relying party further challenge 564 using the relying-party-specific private authentication data 1112.

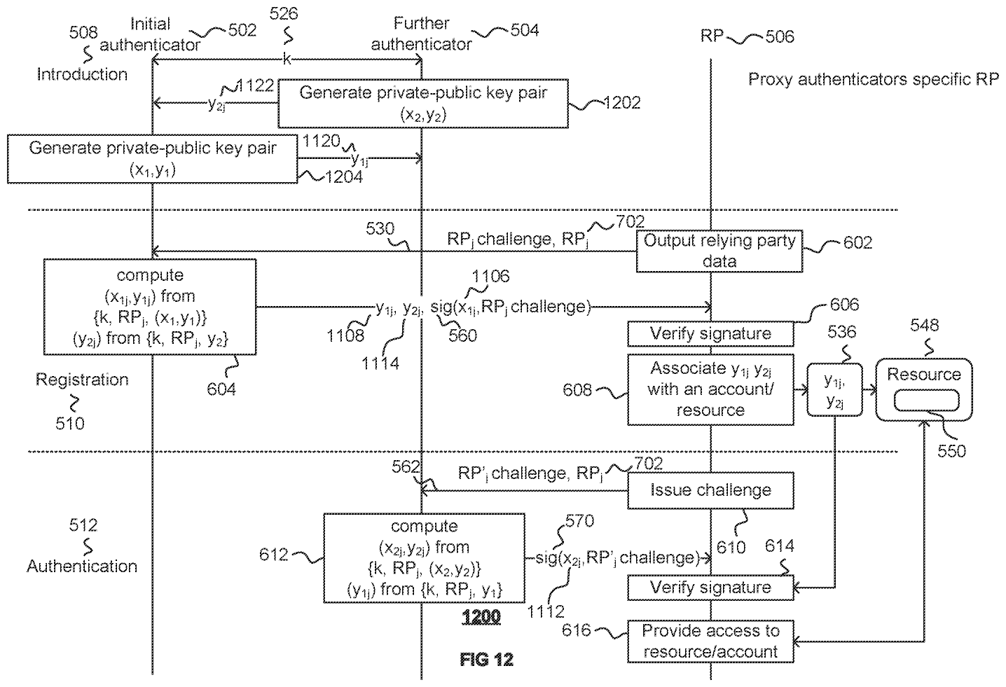

Referring to FIG. 12, there is shown a view 1200 of the signalling and operations performed by the authentication system shown in, and described with reference to, FIGS. 11A-C. Reference numerals common to FIGS. 12 and FIGS. 11A-C refers to the same elements, subject to the differences described below.

During the introductory phase 508, the further authenticator 504 generates, at 1202, further authentication specific authentication public data 1122 that is sent to the initial authenticator 502. Additionally, or alternatively, the initial authenticator 502 generates, at 1204, initial authenticator specific public authentication data 1120 that is sent to the further authenticator 504. The initial authenticator 502 and the further authenticator 504 obtain or generate shared seed data. The shared seed data comprises the shared secret 526 in the example depicted.

During the registration phase 510, at 602, the relying party 506 outputs to the initial authenticator 502 a relying party challenge 530 comprising the above described specific relying party data 702. In the example shown and described above, the specific relying party data 702 can be output with or without the respective challenge 530 to the initial authenticator 502. Accordingly, the private-public key pair, that is, the authentication data, generated during the registration phase 510 will be uniquely associated with the specific relying party 506.

The relying-party-specific authentication data 1106, 1108, 1114 is generated, at 604, by the initial authenticator 502 and output together with proof of possession of the relying-party-specific private authentication data 1106. Such proof can be realised using a signature 560. The signature 560 can be derived from the relying part challenge and the relying-party-specific private authentication data 1106.

At 606, the proof of possession of the relying-party-specific private authentication data 1106 is verified by the verifier 544. If the verification fails, a message (not shown) to that effect is output to the initial authenticator indicating that the registration has failed. If the verification is successful, the relying party 506 allocates resources 548 with the relying-party-specific public authentication data. The allocated resources 548 will be accessible to both the initial authenticator 502 and the further authenticator 504 due to the initial authenticator 502 having nominated the further authenticator 504 as a proxy via the relying-party-specific public authentication data 1114 sent by the initial authenticator 502 to the relying party.

During the authentication phase 512, at 610, the relying party 506 outputs to the further authenticator 504 a relying party challenge communication 562 comprising the relying party challenge 564 and the above described specific relying party challenge data 702. In the example shown and described above, the specific relying party data 702 can be output with or without the respective challenge 562 to the initial authenticator 504.

The further authenticator 504, at 612, calculates proof 570 of possession of relying-party-specific private authentication data 1112 and sends that proof 570 to the relying party 506. The proof 570 can comprise a signature 570. The signature 570 can be realised using the relying party challenge 564 and the relying-party-specific private authentication data 1112. Examples can be realised in which the signature 570 comprises the relying party challenge 564 signed using the relying-party-specific private authentication data 1112.

At 614, the proof of possession of the relying-party-specific private authentication data 1106 is verified by the verifier 544. If the verification fails, a message (not shown) to that effect is output to the further authenticator 504 indicating that the registration has failed. If the verification is successful, the relying party 506 provides access to the resources 548 associated with the relying-party-specific public authentication data corresponding to the relying-party-specific private authentication data 1112. Therefore, the allocated resources 548 will be accessible to the further authenticator 504 even though registration was performed by the initial authenticator due to the initial authenticator 502 having nominated the further authenticator 504 as a proxy via the relying-party-specific public authentication data 1114 sent by the initial authenticator 502 to the relying party.

Therefore, creating and providing access to a commonly accessible resource to multiple authenticators can be realised even when a user has access to a subset of those authenticators and, in particular, even if a user has access to a single authenticator such as the above described initial authenticator 502. This is achievable because the initial authenticator 502 generates or provides to the relying party 506 authentication data relating to or otherwise associated with the further authenticator.

Although the initial authenticator 502 has been described as the authenticator that registers authentication data on behalf of itself and the further authenticator 504 with the relying party 506, examples are not limited to such an arrangement. It can be appreciated from FIGS. 11A-C and 12 that the further authenticator 504 could, equally well, perform the processing undertaken by the initial authenticator 502 and vice-a-versa. Consequently, examples can be realised in which the initial relying party challenge 530 is sent to the further authenticator 504 and in which the further authenticator 504 provides, in response to the challenge, the authentication data together with proof of possession of the private authentication data.

Referring to FIG. 13A there is shown a view 1300A of an authenticator system that is substantially similar to the above authentication systems described with reference to, or as shown in, any of FIGS. 11A-C and 12. Reference numerals common to FIGS. 13A-C and FIGS. 11A-C and 12 refer to the same elements and the above descriptions of FIGS. 11A-C and 12 equally apply to FIGS. 13A-C.

The differences between FIGS. 13A-C and FIGS. 11A-C and 12 will be described.

The authentication system comprises the initial authenticator 502, the further authenticator 504 and the relying party 506. The relying party 506 is a specific relying party that is one of a set of relying parties with which the initial authenticator 502, the further authenticator 504 or both the initial and further authenticators 502, 504 can interact. The set of relying parties is not shown but can comprise one relying party or a number of relying parties.

The authentication system operation and signalling is substantially identical to the authentication system 1100A described above with reference to FIGS. 11A-C and 12 but for supplying the public authentication data 1108, 1114 to the relying party and producing the proof of possession of the private authentication data.

In response to receiving the challenge 530 from the relying party, the initial authenticator 502 uses ring signatures to provide proof of authenticity to the relying party. Therefore, the initial authenticator 502 creates a structured list 1302 comprising all relying-party-specific public authentication data associated with the set of authenticators. In the example depicted in FIG. 13A, the structured list comprises the relying-party-specific public authentication data 1108, 1114.

Also, the initial authenticator 502 uses the function 1102 to create a ring signature 1304 to provide proof of possession of the relying-party-specific private authentication data. The ring signature is formed from the relying party challenge data 556, the relying-party-specific public authentication data 1108, 1114 corresponding to all authenticators in the set of authenticators and the relying-party-specific private authentication data associated with the initial authenticator 502. Referring to FIG. 13B, the structured list 1302 and the associated ring signature 1304 are sent as a message 558 to the relying party 506.

The relying party 506 verifies the ring signature using the verifier 544. If the verifier 544 indicates that the ring signature is invalid, a message to that effect is output to the initial authenticator 502. If the ring signature is determined to be valid, the access controller or resource controller 546 associates resources with the structured list 1302 for future use or access by any authenticator that is able to provide a valid ring signature associated with that structured list 1302.

Referring to FIGS. 13A and 13C, again, in response to receiving the specific relying party challenge 562, comprising the specific relying party challenge data 564, and the specific relying party data 702, the further authenticator 504 generates proof 1306 of possession respective relying-party-specific private authentication data 1112. The proof 1306 of possession of the rely-party-specific private authentication data 1112 can be realised using the specific relying party further challenge 564, the relying-party-specific private authentication data 1112 and the relying-party-specific list 1302 of public authentication data. Examples can be realised in which the proof 1306 is created in the form of the ring signature that, in turn, is derived from the specific relying party further challenge 564, the relying-party-specific private authentication data 1112 and the relying-party-specific list 1302 of public authentication data. In the example depicted, the ring signature 1306 is formed using the rely-party-specific public authentication data 1108 associated with the initial authenticator 502, the rely-party-specific public authentication data 1114 associated with the further authenticator 504, the relying-party-specific private authentication data 1106 associated with the initial authenticator 502, the specific relying party challenge 564 and the seed data. In the example depicted, the seed data comprises the shared secret 526.

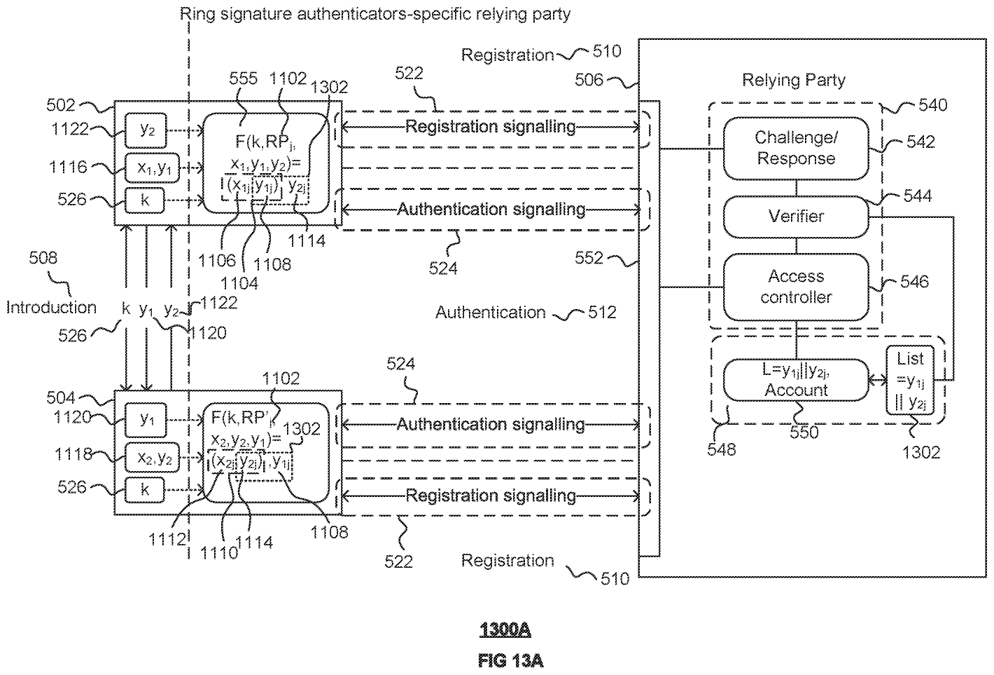

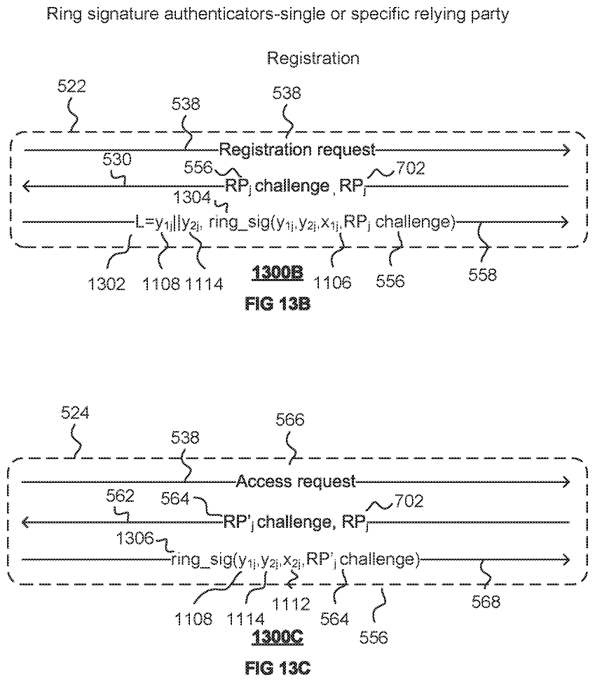

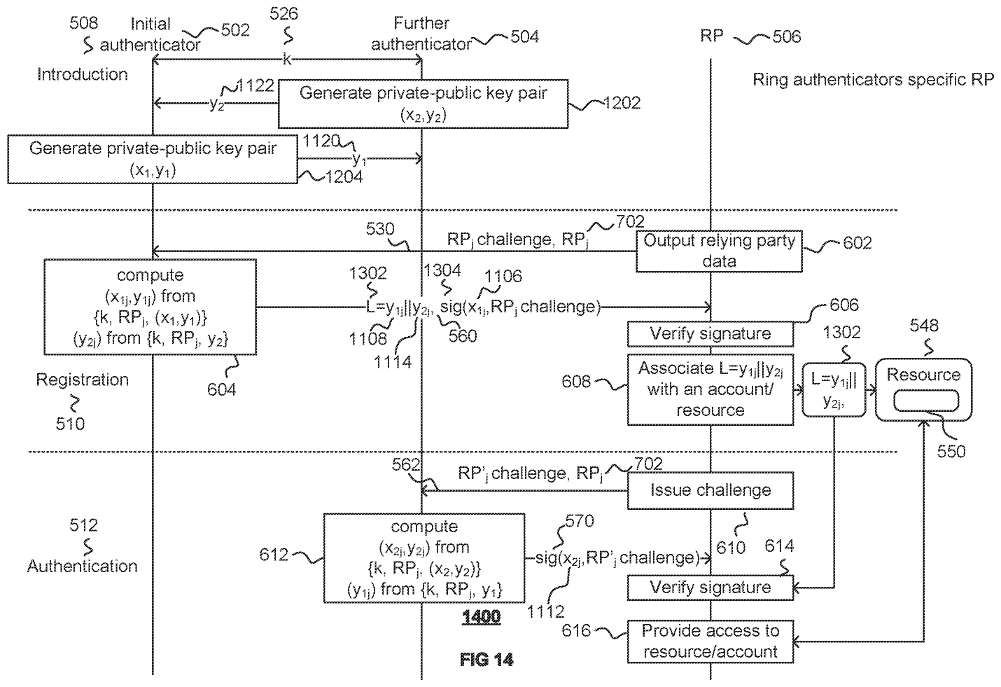

Referring to FIG. 14, there is shown a view of signalling and operations of the authentication system 1300A that is substantially similar to the above authentication systems described with reference to, or as illustrated in, any of FIGS. 11A-C and 12. Reference numerals common to FIG. 14 and FIGS. 13A-C, 11A-C and 12 refer to the same elements and the above descriptions of FIGS. 11A-C and 12 equally apply to FIG. 14.

The differences between FIGS. 12 and 14 will now be described.

In response to the specific relying party challenge 530 issued by the relying party 506, at 602, the initial authenticator 502 creates and outputs, at 604, the structured list of relying-party-specific public authentication data 1302 comprising the public authentication data of the authenticators in the set of authenticators together with the corresponding ring signature 1304. Throughout the description, examples can be realised in which the structured list comprises a structured list of public keys associated with the authenticators in the set of authenticators.

In response to having verified, at 606, the ring signature 1302, the relying party 506 associates, at 608, a resource 548 with the structured list. Examples can be realised in which the resource 548 is the account 550.

Similarly, in response to the specific relying party challenge 562 issued by the relying party 506, at 610, the further authenticator 502 creates and outputs, at 612, the ring signature 1306 derived from the list of relying-party-specific public authentication data 1302 comprising the public authentication data of the authenticators in the set of authenticators, the relying-party-specific private authentication data 1106, the specific relying party further challenge 564 and the seed data. In the example depicted, the seed data comprises the secret 526.

In response to having verified the ring signature 1302, at 614, the relying party 506 provides access, at 616, to the resource 548 associated with the structured list.

Therefore, creating and providing access to a commonly accessible resource to multiple authenticators can be realised even when a user has access to a subset of those authenticators and, in particular, even if a user has access to a single authenticator such as the above described initial authenticator 502. This is achievable because the initial authenticator 502 generates or provides to the relying party 506 authentication data relating to or otherwise associated with the further authenticator. Still further, the authenticators retain a measure of anonymity since ring signatures anonymously vouch for the veracity of the authenticators.

Although the initial authenticator 502 has been described as the authenticator that registers authentication data on behalf of itself and the further authenticator 504 with the relying party 506, examples are not limited to such an arrangement. It can be appreciated from FIGS. 13A-C and 14 that the further authenticator 504 could, equally well, perform the processing undertaken by the initial authenticator 502 and vice-a-versa. Consequently, examples can be realised in which the initial relying party challenge 530 is sent to the further authenticator 504 and in which the further authenticator 504 provides, in response to the challenge, the authentication data together with proof of possession of the private authentication data.

Although the examples described above with reference to FIGS. 13A-C and 14 have used a relying-party-specific context in which the relying party 506 is be a specific relying party of the set of relying parties, examples are not limited to such an arrangement. Examples can be realised in which the set of relying parties comprises one relying party. It will be appreciated that in the case of one relying party, there would be no need for the relying party 506 to provide specific relying party data 702 since the authentication data and signatures generated by the initial authenticator 502 and the further authenticator 504 would not be destined for any other relying parties such that they do not have to distinguish between multiple relying parties.

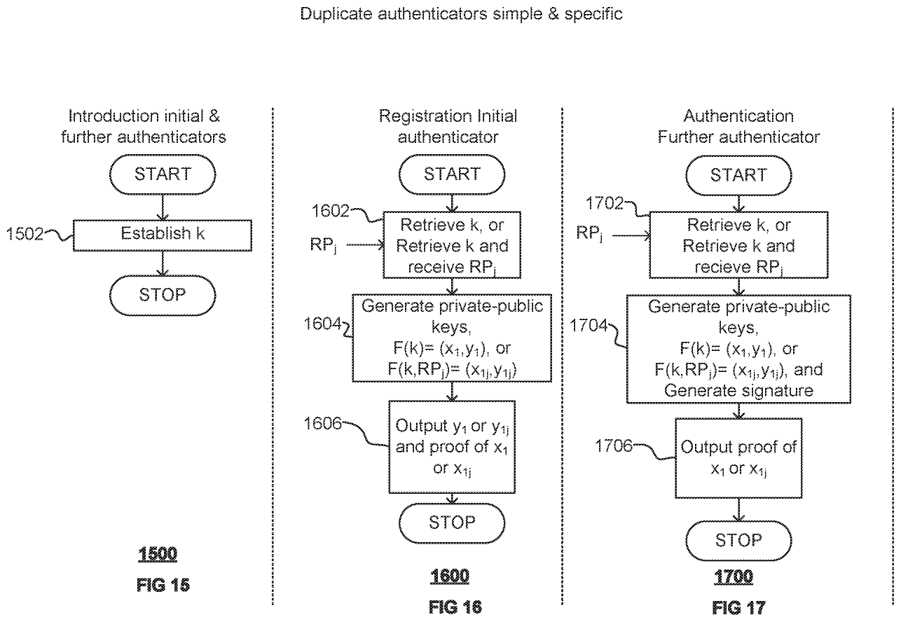

Referring to FIG. 15, there is shown a view 1500 of a flowchart for the introductory phase of the above examples.

At 1502, the seed data is established. Examples can be realised in which the seed data comprises, or is, a secret associated with, established between, accessed by, or transmitted to, the set of authenticators. The set of authenticators can comprise the initial and further authenticators or some other number of authenticators.

Referring to FIG. 16, there is shown a view 1600 of a flowchart for the registration phases of the above examples.

At 1602, the shared secret is established or accessed for examples dealing with a single relying party.

At 1604, the authentication data is generated using the seed data, that is, the shared secret. Alternatively, the authentication data is established using the shared secret and the specific relying party data.

A public portion of the authentication data is output at 1606 for sending to the relying party.

Alternatively, for examples dealing with a set of relying parties comprising multiple relying parties, the shared secret is established and the specific relying party data is established at 1602 and the authentication data is establishing, at 1604, using both the shared secret and the specific relying party data.

Referring to FIG. 17, there is shown a view 1700 of a flowchart for the authentication phases of the above examples.

At 1702, the shared secret is established or accessed for examples dealing with a single relying party.

At 1704, the authentication data is generated using the seed data, that is, the shared secret. Alternatively, the authentication data is established using the shared secret and the specific relying party data. The signature is also generated using the private authentication data corresponding to the public authentication data generated at 1604.

At 1706, proof of possession of the private authentication data is output for sending to the relying party.

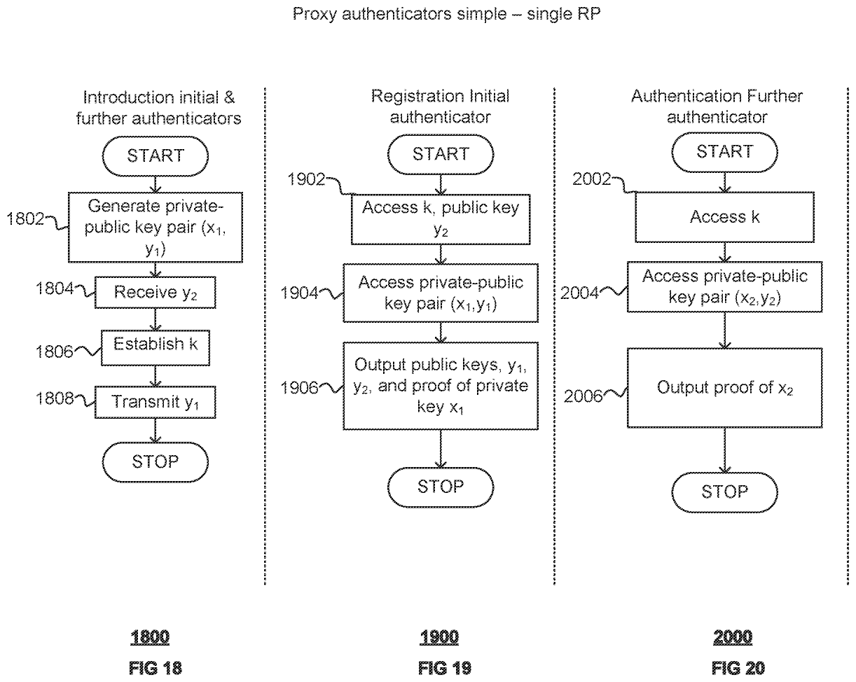

Referring to FIG. 18, there is shown a view 1800 of a flowchart of a further introductory phase according to the above examples.

The initial authenticator 502 obtains initial authentication data at 1802. The initial authentication data can comprise a private-public authentication data such as, for example, a private-public key pair of, or associated with, the initial authenticator. The initial authentication data is an example of initial authenticator specific authentication data.

At 1804, the initial authenticator 502 accesses or receives public authentication data associated with the further authenticator 504. In the example depicted, the received authentication data comprises public authentication data associated with the further authenticator 504. The public authentication data can comprise a public key of a private-public key pair associated with, or of, the further authenticator. The public authentication data or the private-public key pair associated with, or of, the further authenticator 504 are examples of further authenticator specific authentication data. Obtaining the initial authentication data can comprise generating the initial authentication data, accessing the initial authentication data or receiving the initial authentication data.

At 1806, the initial authenticator 502 generates or otherwise establishes a shared secret and public authentication data associated with the further authenticator 504. As indicated above, the shared secret can be issued to the initial authenticator, made available for access by the initial authenticator, or generated in a decentralised manner in conjunction with any other authenticators in a set of authenticators. In the example depicted, the set of authenticators comprises the initial authenticator 502 and the further authenticator 504.

At 1808, the public authentication data of, or associated with, the initial authenticator 502 is output for sending to any other authenticators in the set of authenticators. In the example depicted, the public authentication data is output for transmitting to the further authenticator for use in authenticating the further authenticator 504.

The order of operations in the flowchart 1800 is immaterial providing the public authentication data has been generated before it is output to the further authenticator.

Referring to FIG. 19, there is shown a view 1900 of a flowchart of a further registration phase of some of the above examples.

At 1902, the initial authenticator 502 establishes or otherwise accesses the shared secret and public authentication data associated with the further authenticator 504. The shared secret and public authentication data associated with the further authenticator 504 can be stored or otherwise saved by the initial authenticator 502 following the process of FIG. 18.

At 1904, the private-public authentication data associated with the initial authenticator 502 is accessed using the shared secret, or accessed or otherwise obtained.

At 1906, the public authentication data associated with all authenticators is output for sending to the relying party 506 together with proof of authenticity of that public authentication data associated with all authenticators.

Referring to FIG. 20, there is shown a view 2000 of a flowchart for authenticating the further authenticator 504.

At 2002, the shared secret is established or accessed.

At 2004, the private-public authentication data is accessed using the shared secret as seed data, that is, as source keying material, or otherwise accessed or obtained.

At 2006, proof of possession of the private authentication data is output for sending to the relying party 506.

Referring to FIG. 21, there is shown a view 2100 of a flowchart of an introductory phase according to some examples.

The initial authenticator 502 obtains initial authentication data at 2102. The initial authentication data can comprise a private-public authentication data such as, for example, a private-public key pair of, or associated with, the initial authenticator. The initial authentication data is an example of initial authenticator specific authentication data.

At 2104, the initial authenticator 502 accesses or receives public authentication data associated with the further authenticator 504. In the example depicted, the received authentication data comprises public authentication data associated with the further authenticator 504. The public authentication data can comprise a public key of a private-public key pair associated with, or of, the further authenticator. The public authentication data or the private-public key pair associated with, or of, the further authenticator 504 is an example of further authenticator specific authentication data. Obtaining the initial authentication data can comprise generating the initial authentication data, accessing the initial authentication data or receiving the initial authentication data.

At 2106, the initial authenticator 502 generates or otherwise establishes a shared secret. As indicated above, the shared secret can be issued to the initial authenticator, made available for access by the initial authenticator, or generated in a decentralised manner in conjunction with any other authenticators in a set of authenticators. In the example depicted, the set of authenticators comprises the initial authenticator 502 and the further authenticator 504.

At 2108, the public authentication data of, or associated with, the initial authenticator 502 is output for sending to any other authenticators in the set of authenticators. In the example depicted, the public authentication data is output for transmitting to the further authenticator for use in authenticating the further authenticator 504.

The order of operations in the flow chart 2100 is immaterial providing the public authentication data is generated in advance of sending the public authentication data to the further authenticator.

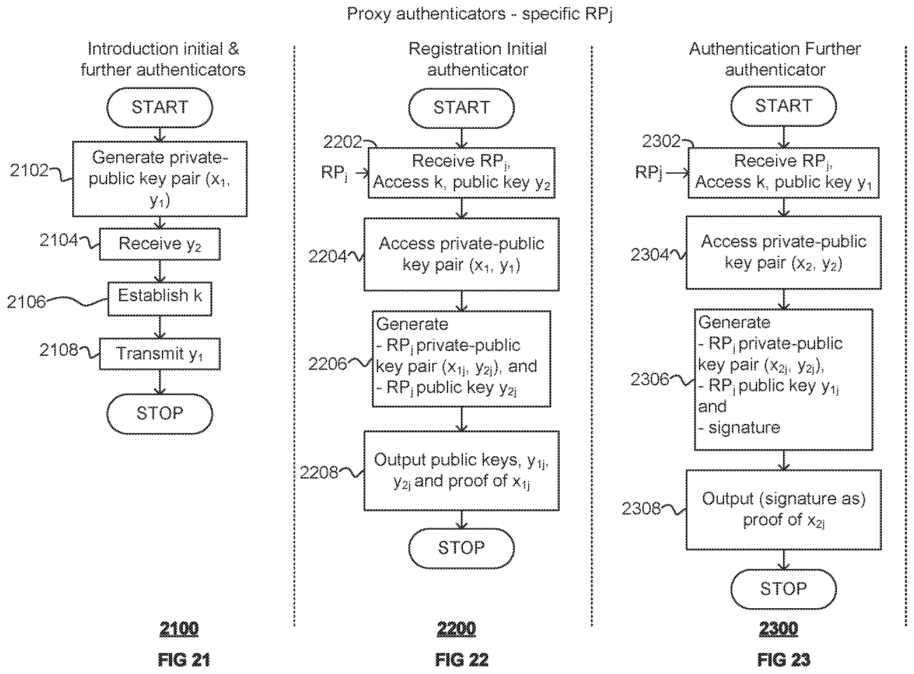

Referring to FIG. 22, there is shown a view 2200 of a flowchart of a registration phase according to some examples.

At 2202, the initial authenticator 502 receives specific relying party data, and establishes or accesses the shared secret and a set of public authentication data associated with the set of authenticators. In the example shown, the set of public authentication data comprises public authentication data associated with the further authenticator 504.

At 2204, private-public authentication data associated with the initial authenticator 502 is established or accessed.

At 2206, the initial authenticator generates relying-party-specific private-public authentication data using the private-public authentication data established at 2204, and generates relying-party-specific authentication data associated with the set of received public authentication data associated with the set of authenticators.

At 2208, the relying-party-specific public authentication data is output together with proof of the authenticity of that relying-party-specific public authentication data. Examples can be realised in which the proof of possession comprises a signature. The signature, as indicated above, can be derived from the specific relying party data and the private authentication data associated with the initial authenticator 502.

Referring to FIG. 23, there is shown a view 2300 of a flowchart of an authentication phase according to some examples.

At 2302, the further authenticator 504 receives specific relying party data, and establishes or accesses the shared secret and a set of public authentication data associated with the set of authenticators.

At 2304, private-public authentication data associated with the further authenticator 504 is established or accessed.

At 2306, the further authenticator 504 generates relying-party-specific private-public authentication data using the private-public authentication data established at 2304, generates relying-party-specific authentication data associated with the set of received public authentication data associated with the set of authenticators.

At 2308, the proof of the possession of relying-party-specific private authentication data is output for sending to the relying party.

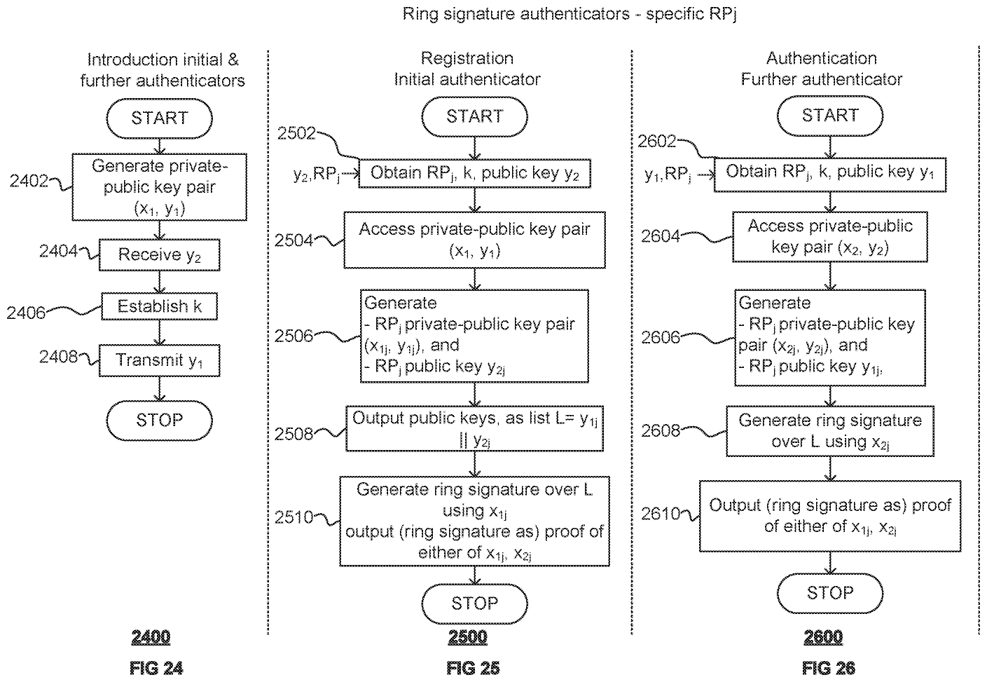

Referring to FIG. 24, there is shown a view 2400 of an introductory phase according to some examples described above.

The initial authenticator 502 obtains initial authentication data at 2402. The initial authentication data can comprise a private-public authentication data such as, for example, a private-public key pair of, or associated with, the initial authenticator. The initial authentication data is an example of initial authenticator specific authentication data.

At 2404, the initial authenticator 502 accesses or receives public authentication data associated with the further authenticator 504. In the example depicted, the received authentication data comprises public authentication data associated with the further authenticator 504. The public authentication data can comprise a public key of a private-public key pair associated with, or of, the further authenticator. The public authentication data or the private-public key pair associated with, or of, the further authenticator 504 is an example of further authenticator specific authentication data. Obtaining the initial authentication data can comprise generating the initial authentication data, accessing the initial authentication data or receiving the initial authentication data.

At 2406, the initial authenticator 502 generates or otherwise establishes a shared secret and public authentication data associated with the further authenticator 504. As indicated above, the shared secret can be issued to the initial authenticator, made available for access by the initial authenticator, or generated in a decentralised manner in conjunction with any other authenticators in a set of authenticators. In the example depicted, the set of authenticators comprises the initial authenticator 502 and the further authenticator 504.

At 2408, the public authentication data or, or associated with, the initial authenticator 502 is output for sending to any other authenticators in the set of authenticators. In the example depicted, the public authentication data is output for transmitting to the further authenticator for use in authenticating the further authenticator 504.

The order of operations in the flow chart 2400 is immaterial providing the public authentication data is generated in advance of sending the public authentication data to the further authenticator.

Referring to FIG. 25, there is shown a view 2500 of a flowchart of a registration phase according to some examples.

At 2502, the initial authenticator 502 receives specific relying party data, and establishes or accesses the shared secret and a set of public authentication data associated with the set of authenticators. In the example depicted, the set of public authentication data comprises public authentication data associated with the further authenticator 504.

At 2504, private-public authentication data associated with the initial authenticator 502 is established or accessed.

At 2506, the initial authenticator 502 generates relying-party-specific private-public authentication data using the private-public authentication data established at 2504 and the received specific relying party data as source keying material or seed data, and generates relying-party-specific authentication data associated with the set of received public authentication data associated with the set of authenticators using the set of public authentication data and the relying party specific data received at 2502.

At 2508, the initial authenticator 502 establishes a structured list comprising relying-party-specific public authentication data associated with the set of authenticators, and outputs the list for sending to the relying party 506.

At 2510, proof of possession of the relying-party-specific private authentication data is generated and output for sending to the relying party 506. In the example shown, the proof of possession can comprises a ring signature that is generated over the structured list using relying-party-specific private authentication data.

Referring to FIG. 26, there is shown a view 2600 of a flowchart of an authentication phase according to some examples.

At 2602, the further authenticator 504 receives specific relying party data, and establishes or accesses the shared secret and a set of public authentication data associated with the set of authenticators. In the example shown, the set of public authentication data associated with the set of authenticators comprises the public authentication data associated with the initial authenticator 502.

At 2604, the private-public authentication data associated with the further authenticator 504 is established or accessed.

At 2606, the further authenticator 504 generates relying-party-specific private-public authentication data using the private-public authentication data established and the specific relying party data at 2604, and generates relying-party-specific authentication data associated with the set of received public authentication data associated with the set of authenticators and the specific relying party data.

At 2608, a ring signature is generated over the structured list using relying-party-specific private authentication data.

At 2610, proof of possession of relying-party-specific private authentication data is output for sending to the relying party. The proof can comprise the ring signature.

Examples can be realised in the form of machine instructions that can be processed by a machine. The machine can comprise a computer, processor, DSP, FPGA, circuitry or other logic, processor core, compiler, translator, interpreter, or any other instruction processor. Processing the instructions can comprise interpreting, executing, converting, translating or otherwise giving effect to the instructions. The instructions can be stored using a machine readable medium. The machine readable medium can store the instructions in a non-volatile, non-transient, manner or in a volatile, transient, manner. The instructions can be arranged to give effect to any and all operations described herein taken jointly and severally in any and all permutations. The instructions can be arranged to give effect to any and all of the operations, the systems, the devices, the flow charts, the protocols or the methods described herein taken jointly and severally in any and all permutations.

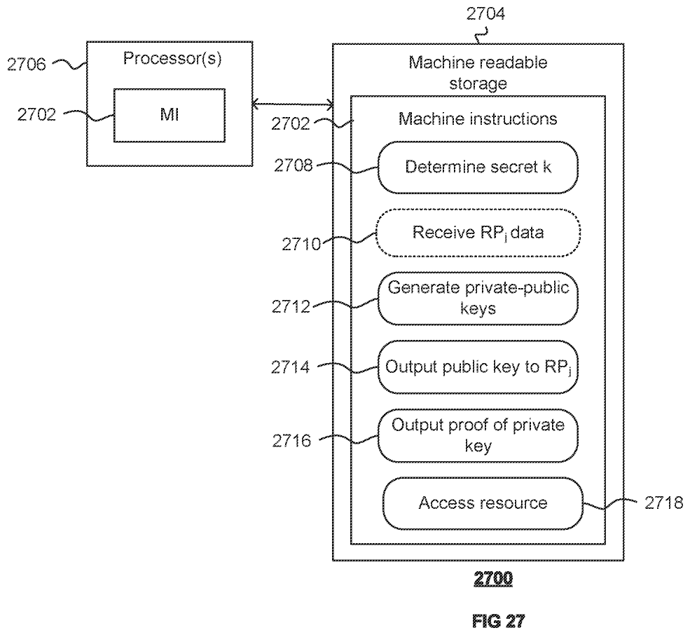

Therefore, FIG. 27 shows a view 2700 of machine instructions 2702 stored on machine readable storage 2704 for implementing the examples described herein. The instructions can be processed by a processor 2706 or other entity.

The machine readable storage comprises instructions to give effect to processing defined above in the examples or described herein.

The machine 2702 instructions comprise:
Instructions 2708 to establish the seed data. Examples can be realised in which the seed data comprises, or is, the secret associated with, established between, accessed by, or transmitted to, the set of authenticators. The set of authenticators can comprise the initial and further authenticators;
Instructions 2710 to receive specific relying party data; the relying party data instructions are shown in dashed-lines since not all examples use the relying party data;
Instructions 2712 to generate the authentication data using the seed data, that is, the shared secret. Alternatively, the authentication data is established using the shared secret and the specific relying party data;
Instructions 2714 to output a public portion of the authentication data for sending to the relying party;
Instructions 2716 for outputting proof of possession of a private portion of the authentication data; or
Instructions 2718 to access the resource;
   taken jointly and severally in any and all permutations.

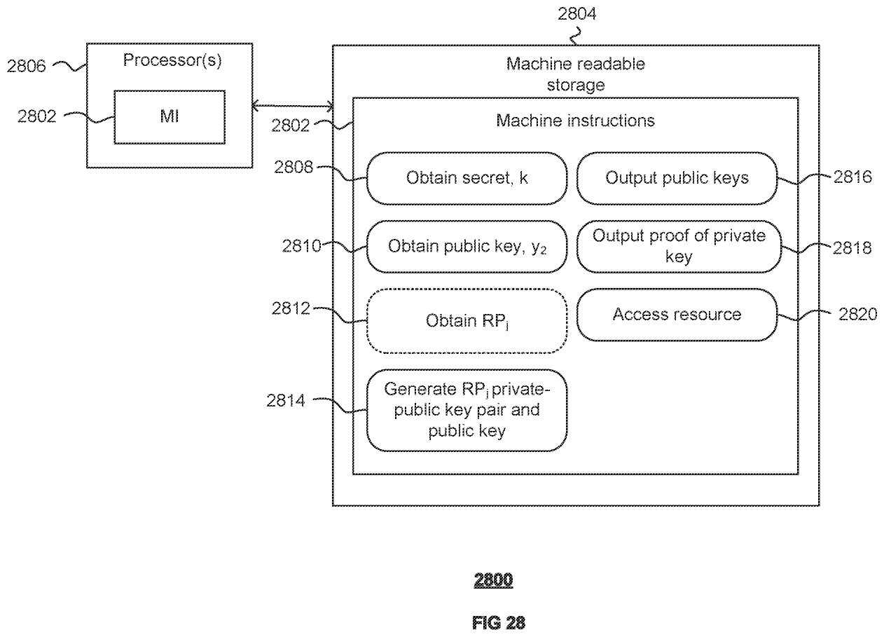

Referring to FIG. 28, there is shown a view 2800 of machine instructions 2802 stored on machine readable storage 2804. The machine instructions can be processed by a processor 2806 or other entity.

The machine instructions 2802 comprise:
Instructions 2808 to generate or otherwise establish a shared secret and public authentication data associated with the set of authenticators;
Instructions 2810 to establish or access public authentication data associated with the set of authenticators;
Instructions 2812 to obtain or receive relying-party-specific data; the instructions 2812 are shown in dashed form since not all examples use the relying-party-specific data;
Instructions 2814 to generate relying-party-specific authentication data comprising relying-party-specific private-public authentication data;
Instructions 2816 to output the relying-party-specific public authentication data;
Instructions 2818 to output proof of possession of the relying-party-specific private authentication data; or
Instructions 2820 to access relying party resources;
taken jointly and severally in any and all permutations.

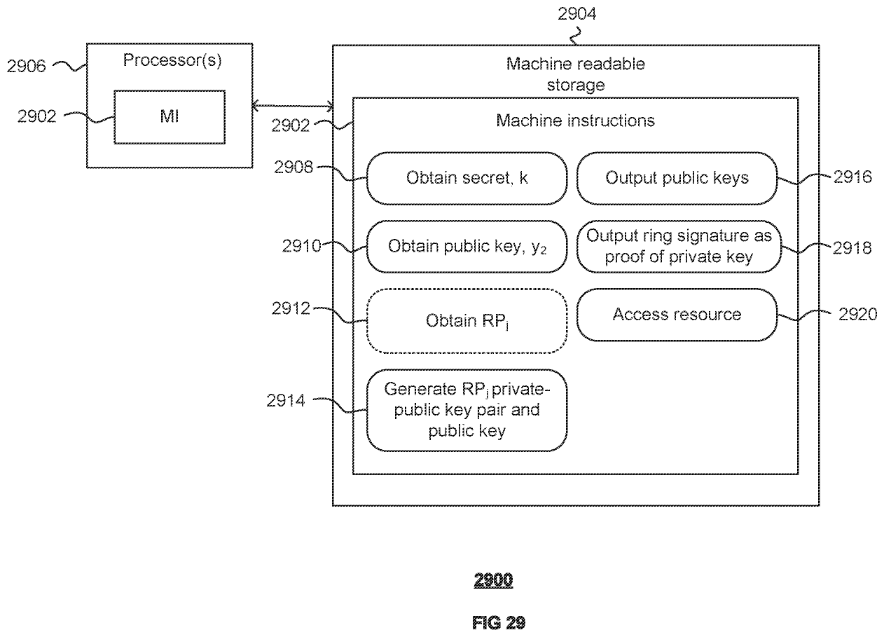

Referring to FIG. 29, there is shown a view 2900 of machine instructions 2902 stored on machine readable storage 2904. The machine instructions can be processed by a processor 2906 or other entity.

The machine instructions 2902 comprise:
Instructions 2908 to generate or otherwise establish a shared secret and public authentication data associated with the set of authenticators;
Instructions 2910 to establish or access public authentication data associated with the set of authenticators;
Instructions 2912 to obtain or receive relying-party-specific data; the instructions 2912 are shown in dashed form since not all examples use the relying-party-specific data;
Instructions 2914 to generate relying-party-specific authentication data comprising relying-party-specific private-public authentication data;
Instructions 2916 to output the relying-party-specific public authentication data;
Instructions 2918 to output proof of possession of the relying-party-specific private authentication data the proof of possession can comprise the ring signature; or
Instructions 2920 to access relying party resources;
   taken jointly and severally in any and all permutations.

Therefore, the examples described herein provide methods, machines, software, hardware, firmware, combinations of hardware and software, systems, and devices for authentication using an authenticator or a number of authenticators or of authenticating using an authenticator or a number of authenticators. Any and all methods described can support or provide authentication of a user or of multiple users. Any and all methods described can support or provide authentication of a device or machine or of devices or machines. Any and all methods can provide or support authentication of a combination of a user and a device or a machine or of a combination of users and devices or machines. The items circuitry, hardware, software, firmware, machine instructions, taken jointly and severally in any and all permutations constitute logic to perform a respective function or operation.

The above examples have been described with reference to using functions to generate the authentication data to be sent to a relying party; namely, functions 108, 208, 308, 555. Examples can be realised in which the functions are key derivation functions that take a source of initial keying material, or sources of initial keying material, and derive from that source, or those sources, of initial keying material a cryptographic key or a number of cryptographic keys. The authentication data described herein can be realised using, or as, such a cryptographic key or such cryptographic keys. Examples can be realised in which any or all of the key derivation functions can comprise, for example, a Hashed Message Authentication Code (HMAC)-based key derivation function (HKDF) or other key derivation function. Such an HKDF is described in, for example, Internet Engineering Task Force (IETF) RFC 5869, ISSN: 2070-1721, by H. Krawczyk and P. Eronen, May 2010, which is incorporated herein for all purposes by reference together with any and all other papers referenced in RFC 5869.

Therefore, it will be appreciated that the authentication data, or key derivation process, can be specific to each example. Furthermore, the exact construction of a given private-public key pair might also depend on the type of signature used to authenticate to the relying party.

In the above examples relating to duplicate authenticators, using the shared secret, k, and the specific relying party data, RPⱼ, each of the authenticators in the set of authenticators generates the same private-public key pair (xⱼ,yⱼ) or (x,y) for a single relying party. Characteristics of the key derivation process can be any or all of the following taken jointly and severally in any and all permutations:
the key pairs (xⱼ,yⱼ) are unique for each relying party. This follows since using the same public key across multiple relying parties can lead to vulnerabilities in privacy. For example, relying parties that collaborate can track the activity of a given authenticator by tracking the same public key.
the key pairs (xⱼ,yⱼ) are derived during registration and authentication protocols, which reduces the information stored by the authenticators. Instead of storing unique keys for every relying party, each authenticator can repeatedly derive the keys when needed.
each authenticator in the set of authenticators is able to derive the key pairs (xⱼ,yⱼ), which allows authenticators to register a public key such that any authenticator in the set can generate the corresponding private key. Consequently, multiple authenticators can be registered with only one authenticator present.
other than other authenticators in the set, no other entity should be able to derive (xⱼ,yⱼ), otherwise other entities would be able to correlate the public keys across different relying parties, creating the same privacy vulnerability as reusing public keys.
after the introduction phase, the authenticators do not need to communicate. For example, if the initial authenticator registers itself and the further authenticator with a relying party, the initial authenticator does not need to update the further authenticator. Even if the initial authenticator is lost or broken, the further authenticator can still derive the requisite keys.

In the above examples that nominate proxy authenticators, using the shared secret, k, a j^{th} specific relying party data, RPⱼ, a private-public key pair (xₘ,yₘ) of an m^{th} authenticator, and a public key yₙ, of a further authenticator, the m^{th} authenticator derives a private-public key pair (xₘⱼ,yₘⱼ) and a public key, yₙⱼ, and using the shared secret, k, a j^{th} specific relying party data, RPⱼ, a private-public key pair (xₙ,yₙ) of the n^{th} authenticator, and a public key yₘ, of the m^{th} authenticator, the n^{th} authenticator derives a private-public key pair (xₙⱼ,yₙⱼ) and a public key, yₘⱼ. The key derivation process comprises any or all of the following taken jointly and severally in any and all permutations:
the key pairs (xᵢⱼ,yᵢⱼ) are unique for each relying party. This follows since using the same public key across multiple relying parties can lead to vulnerabilities in privacy. For example, relying parties that collaborate can track the activity of a given authenticator by tracking the same public key.
the key pairs (xᵢⱼ,yᵢⱼ) are derived during registration and authentication protocols, which reduces the information stored by the authenticators. Instead of storing unique keys for every relying party, each authenticator can repeatedly derive the keys when needed.
each authenticator in the set of authenticators is able to derive all of the yᵢⱼ, which allows authenticators to nominate proxies that can authenticate to the same relying party. Consequently, multiple authenticators can be registered with only one authenticator present.
other than other authenticators in the set, no other entity should be able to derive the public keys yᵢⱼ, otherwise other entities would be able to correlate the public keys across different relying parties, creating the same privacy vulnerability as reusing public keys.
each authenticator in the set should be able to derive exactly one private key xᵢⱼ.
after the introduction phase, the authenticators do not need to communicate. For example, if the initial authenticator registers itself and the further authenticator with a relying party, the initial authenticator does not need to update the further authenticator. Even if the initial authenticator is lost or broken, the further authenticator can still derive the requisite keys.

In the above examples that use ring signatures, that is, ring authenticators, using the shared secret, k, a j^{th} specific relying party data, RPⱼ, a private-public key pair (xₘ,yₘ) of an m^{th} authenticator and a public key yₙ, of a further authenticator, the m^{th} authenticator derives a private-public key pair (xₘⱼ,yₘⱼ) and a public key, yₙⱼ, and using the shared secret, k, a j^{th} specific relying party data, RPⱼ, a private-public key pair (xₙ,yₙ) of the n^{th} authenticator, and a public key yₘ, of the m^{th} authenticator, the n^{th} authenticator derives a private-public key pair (xₙⱼ,yₙⱼ) and the public key, yₘⱼ. The key derivation process for ring authenticators is similar to the above process for proxy authenticators with the difference being that a signing authenticator nominates members of a ring that can authenticate to the same relying party.

In the above, it can be appreciated that for the duplicate authenticator examples, that is, the examples described with reference to FIGS. 5A to 8, 15-17, 27, each authenticator in the set can generate the same set of public keys and a valid private key for each relying party using the shared secret. During registration, one of the authenticators generates the key pair and registers the public key with the relying party. During authentication, any authenticator in the set can generate the same key pair and use the corresponding private key to authenticate to the relying party.

In the above proxy authenticator examples, that is, the examples described with reference to FIGS. 9A to 12, 18 to 23 and 28, each authenticator in the set can generate the same set of public keys, and one valid private key, for each relying party, using a shared secret. During registration, one authenticator generates the set of public keys and registers the set of public keys with the relying party, which involves generating the private key, corresponding to one of the public keys, and using the private key to create a signature. The other public keys in the set are used to nominate proxies. During authentication, any authenticator nominated as a proxy can generate a key pair where the public key is equal to one of the public keys provided during registration; the key pair is used to authenticate to the relying party.

In the above ring signature examples, that is, the examples described with reference to FIGS. 13A to 14, 24 to 26 and 29, each authenticator in the set of authenticators can generate the same ordered list of public keys, and a valid ring signature for a relying party using a shared secret. During registration, one authenticator generates a list of public keys and registers it with the relying party, which involves generating a private key, corresponding to one of the public keys, and using the private key to create a ring signature. The other public keys in the list are used to nominate other members of the ring. During authentication, any authenticator nominated as a member of the ring can generate the same list of public keys and a private key corresponding to one of the public keys, and can then create a valid ring signature and authenticate to the relying party. Given two valid ring signatures from two different authenticators, a relying party cannot distinguish between the two authenticators. Therefore, the authenticators can be anonymous.

It will be appreciated that the above are examples of authentication using ‘what you have’, which can complement or replace authentication using ‘what you know’. The concept of ‘what you have’ consists of devices in a user's possession, which are the above described authenticators. Examples of authenticators comprises a laptop with a hardware anchor such as, for example, a Trusted Platform Module, or a roaming security key such as a YubiKey. During registration and authentication, these devices interact with a relying party. The interaction is facilitated by software that is standardised across authenticators and relying parties such as, for example, FIDO2. The examples presented herein can be combined with such protocols to improve authentication systems such as FIDO2.

Examples can be realised according to the following clauses:

Clause 1: A method of authentication using an authenticator, the method comprising: generating, by an initial authenticator (A1), a public key (yj,y2,j) associated with a further authenticator (A2) using a secret (k) associated with the initial authenticator and the further authenticator; and outputting the public key associated with the further authenticator for sending to a relying party.

Clause 2: The method of clause 1, in which generating, by an initial authenticator (A1), a public key (yj,y2,j) associated with a further authenticator (A2) using secret (k) associated with the initial authenticator and the further authenticator comprises: generating, by an initial authenticator (A1), a public key (yj,y2,j) associated with the further authenticator (A2) using relying party data (RPj) associated with the relying party and the secret (k) associated with the initial authenticator and the further authenticator.

Clause 3: The method of clause 2, in which generating, by the initial authenticator (A1), the public key (yj,y2,j) associated with the further authenticator (A2) using the secret (k) and the relying party data (RPj) comprises: generating a private-public key pair [(x1,y1),(x1,j,y1,j)] associated with the initial authenticator using the secret and the relying party data.

Clause 4: The method of clause 3, comprising setting the public key (y2) associated with the further authenticator to equal the public key associated with the initial authenticator.

Clause 5: The method of either of clauses 3 and 4, in which generating the private-public key pair [(x1,j,y1,j)] associated with the initial authenticator using the secret and the relying party data comprises: generating a relying party specific private-public key pair [(x1,j,y1,j)] associated with the initial authenticator using the secret, the relying party data and an earlier established private-public key pair (x1,y1) associated with the initial authenticator, and in which outputting the public key associated with the further authenticator for sending to the relying party comprises: outputting the relying party specific public key (y1,j) associated with the initial authenticator for sending to the relying party.

Clause 6: The method of any preceding clause, in which generating the public key (y2,j) associated with the further authenticator using the secret (k) and the relying party data (RPj) comprises: generating a relying party specific public key (y2,j) associated with the further authenticator using the secret, the relying party data and an earlier established public key (y2) associated with the further authenticator, and in which outputting the public key associated with the further authenticator for sending to the relying party comprises: outputting the unique/replying party specific public key (y2,j) associated with the further authenticator for sending to the relying party.

Clause 7: The method of any preceding clause, in which outputting the public key associated with the further authenticator for sending to the relying party comprises: outputting a structured data set (L=y1,j∥y2,j), comprising the public key associated with the further authenticator; the structured data set being associated with a ring signature for sending to the relying party.

Clause 8: The method of clause 7, in which outputting the structured data set (list, L=y1,j∥y2,j) comprising the public key associated with the further authenticator comprises: outputting a structured data set (list, L=y1,j∥y2,j) comprising the public key (y2,j) associated with the further authenticator (A2) and a public key (y1,j) associated with the initial authenticator (A1). (RING)

Clause 9: The method of any preceding clause, further comprising: generating a signature using at least a private key associated with the further authenticator, and outputting the signature for sending to the relying party.

Clause 10: An authentication method to authenticate at least one, or both, of a user or a user device, to a relying party (RP) using an authenticator, the method comprising: generating, by an initial authenticator (A2), a private key (xj,x2,j) corresponding to a public key (yj,y2j) previously provided to the relying party (RP) by a further authenticator (A1) using: relying party data (RPj) associated with the relying party, and a secret (k) associated with the initial authenticator and the further authenticator; and outputting, for sending to the relying party (RP), data proving access to or possession of, by the initial authenticator (A2), the private key (xj,x2,j) corresponding to the public key (yj,y2j) previously provided to the replying party (RP) by the further authenticator (A1).

Clause 11: The method of clause 10, in which generating, by an initial authenticator (A2), the private key (xj,x2,j) corresponding to the public key (yj,y2j) previously provided to the relying party (RP) by a further authenticator (A1) using a secret (k) associated with the initial authenticator and the further authenticator, comprises generating, by an initial authenticator (A2), the private key (xj,x2,j) corresponding to the public key (yj,y2j) previously provided to the relying party (RP) by the further authenticator (A1) using relying party data (RPj) associated with the relying party and the secret (k) associated with the initial authenticator and the further authenticator.

Clause 12: The method of either of clauses 10 and 11, in which generating, by the initial authenticator (A2), the private key (xj,x2,j) corresponding to the public key (yj,y2j) previously provided to the relying party (RP) by the further authenticator (A1) comprises: generating a private-public key pair [(x2,y2),(x2,j,y2,j)] associated with the initial authenticator (A2) using the secret (k) and, optionally, the relying party data (RPj).

Clause 13: The method of clause 12, in which generating the private-public key pair [(x2,j,y2,j)] associated with the initial authenticator (A2) using the secret (k) and the relying party data (RPj) comprises: generating a relying party specific private-public key pair [(x2,j,y2,j)] associated with the initial authenticator (A2) using the secret (k), the relying party data (RPj) and an earlier established private-public key pair (x2,y2) associated with the initial authenticator (A2).

Clause 14: The method of any of clauses 10 to 13, in which outputting, for sending to the relying party (RP), data proving access to or possession of, by the initial authenticator (A2), the private key (xj,x2,j) corresponding to the public key (yj,y2j) previously provided to the replying party (RP) by the further authenticator (A1) comprises: outputting a signature associated with a plurality of public keys, comprising: a public key (y1j) associated with the further authenticator (A1) and the public key (y2,j) associated with the initial authenticator (A2).

Clause 15: The method of clause 14, in which outputting a signature associated with a plurality of public keys comprising: a public key (y1j) associated with the further authenticator (A1) and the public key (y2,j) associated with the initial authenticator (A2) comprises: outputting a signature associated with a structured data set (List: L=y1,j∥y2,j), comprising the public key (y1j) associated with the further authenticator (A1) and the public key (y2,j) associated with the initial authenticator (A2).

Clause 16: The method of clause 15, in which the signature associated with the structured data set comprises a ring signature for sending to the relying party.

Clause 17: The method of clauses 14 to 16, in which outputting, for sending to the relying party (RP), the data proving access to or possession of, by the initial authenticator (A2), the private key (xj,x2,j) corresponding to the public key (yj,y2j) previously provided to the replying party (RP) by the further authenticator (A1) comprises: outputting the signature for sending to the relying party.

Clause 18: A multiphase authentication process comprising a plurality of phases; the phases comprising: an initial phase comprising establishing a shared secret associated with an initial authenticator and a further authenticator, a registration phase comprising: establishing, by the initial authenticator, public authentication data associated with both the initial authenticator and the further authenticator using the shared secret and, optionally, relying party data associated with a relying party, outputting the public authentication data to the relying party for associating with a resource to be accessible to the initial authenticator and the further authenticator; and an authentication phase comprising: receiving, by a receiving authenticator of the initial or further authenticators, relying party data, establishing, by the receiving authenticator, a signature associated with the public authentication data, and outputting the signature to the relying party to gain access to the resource.

Clause 19: The method of clause 18, in which establishing, by the initial authenticator, public authentication data associated with both the initial authenticator and the further authenticator using the shared secret and relying party data associated with a relying party comprises: establishing, by the initial authenticator, private-public authentication data using the shared secret and relying party data associated with the relying party; the private-public authentication data being associated with at least one, or both, of the initial authenticator and the further authenticator.

Clause 20: The method of clause 19, in which establishing, by the initial authenticator, private-public authentication data using the shared secret and relying party data associated with the relying party; the private-public authentication data being associated with at least one, or both, of the initial authenticator and the further authenticator comprises: establishing private-public authentication data associated with the initial authenticator using the secret and relying party data.

Clause 21: The method of any of clauses 19 to 20, in which establishing private-public authentication data associated with the initial authenticator using the secret and relying party data comprises: establishing private-public authentication data associated with the initial authenticator using the secret, relying party data and earlier authentication data associated with the initial authenticator.

Clause 22: The method of any clauses 18 to 21, in which establishing, by the initial authenticator, private-public authentication data using the shared secret and relying party data associated with the relying party; the private-public authentication data being associated with at least one of the initial authenticator and the further authenticator, comprises: establishing public authentication data associated with the further authenticator using the secret and relying party data.

Clause 23: The method of clause 22, in which establishing public authentication data associated with the further authenticator using the secret and relying party data comprises: establishing public authentication data associated with the further authenticator using the secret, relying party data and earlier authentication data associated with the further authenticator.

Clause 24: The method of any of clauses 18 to 23, in which the resource is an account associated with the initial authenticator and the further authenticator.

Clause 25: Machine instructions arranged, when processed, to implement a method of any preceding clause.

Clause 26: Machine readable storage storing machine instructions of clause 25.

Clause 27: A system or device comprising logic to implement a method of any of clauses 1 to 24.

Clause 28: Machine readable storage storing instructions arranged, when processed, to implement authentication using an authenticator, the instructions comprising instructions to: generate, by an initial authenticator (A1), a public key (yj,y2,j) associated with a further authenticator (A2) using a secret (k) associated with the initial authenticator and the further authenticator; and output the public key associated with the further authenticator for sending to a relying party.

Clause 29: The machine readable storage of clause 28, in which the instructions to generate, by an initial authenticator (A1), a public key (yj,y2,j) associated with a further authenticator (A2) using secret (k) associated with the initial authenticator and the further authenticator comprise instructions to: generate, by an initial authenticator (A1), a public key (yj,y2,j) associated with the further authenticator (A2) using relying party data (RPj) associated with the relying party and the secret (k) associated with the initial authenticator and the further authenticator.

Clause 30: The machine readable storage of clause 29, in which the instructions to generate, by the initial authenticator (A1), the public key (yj,y2,j) associated with the further authenticator (A2) using the secret (k) and the relying party data (RPj) comprise instructions to: generate a private-public key pair [(x1,y1),(x1,j,y1,j)] associated with the initial authenticator using the secret and the relying party data.

Clause 31: The machine readable storage of clause 30, comprising instructions to set the public key (y2) associated with the further authenticator to equal the public key associated with the initial authenticator.

Clause 32: The machine readable storage of either of clauses 30 and 31, in which the instructions to generate the private-public key pair [(x1,j,y1,j)] associated with the initial authenticator using the secret and the relying party data comprise instructions to: generate a relying party specific private-public key pair [(x1,j,y1,j)] associated with the initial authenticator using the secret, the relying party data and an earlier established private-public key pair (x1,y1) associated with the initial authenticator, and in which the instructions to output the public key associated with the further authenticator for sending to the relying party comprise instructions to: output the relying party specific public key (y1,j) associated with the initial authenticator for sending to the relying party.

Clause 33: The machine readable storage of any of clauses 28 to 33, in which the instructions to generate the public key (y2,j) associated with the further authenticator using the secret (k) and the relying party data (RPj) comprise instructions to: generate a relying party specific public key (y2,j) associated with the further authenticator using the secret, the relying party data and an earlier established public key (y2) associated with the further authenticator, and in which the instructions to output the public key associated with the further authenticator for sending to the relying party comprise instructions to output the relying party specific public key (y2,j) associated with the further authenticator for sending to the relying party.

Clause 34: The machine readable storage of any of clauses 28-33, in which the instructions to output the public key associated with the further authenticator for sending to the relying party comprise instructions to: output a structured data set (L=y1,j∥y2,j), comprising the public key associated with the further authenticator; the structured data set being associated with a ring signature for sending to the relying party. (RING)

Clause 35: The machine readable storage of clause 34, in which the instructions to output the structured data set (list, L=y1,j∥y2,j) comprising the public key associated with the further authenticator, comprise instructions to: output a structured data set (list, L=y1,j∥y2,j) comprising the public key (y2,j) associated with the further authenticator (A2) and a public key (y1,j) associated with the initial authenticator (A1).

Clause 36: The machine readable storage of any of clauses 28 to 35, further comprising instructions to: generate a signature using at least the private key associated with the further authenticator, and output the signature for sending to the relying party.

Clause 37: Machine readable storage storing instructions arranged, when processed, to implement an authentication method to authenticate a user, or a user device, to a relying party (RP) using an authenticator, the instructions comprising instructions to: generate, by an initial authenticator (A2), a private key (xj,x2,j) corresponding to a public key (yj,y2j) previously provided to the relying party (RP) by a further authenticator (A1) using: relying party data (RPj) associated with the relying party, and a secret (k) associated with the initial authenticator and the further authenticator; and output, for sending to the relying party (RP), data proving access to or possession of, by the initial authenticator (A2), the private key (xj,x2,j) corresponding to the public key (yj,y2j) previously provided to the replying party (RP) by the further authenticator (A1).

Clause 38: The machine readable storage of clause 37, in which the instructions to generate, by an initial authenticator (A2), the private key (xj,x2,j) corresponding to the public key (yj,y2j) previously provided to the relying party (RP) by a further authenticator (A1) using: a secret (k) associated with the initial authenticator and the further authenticator, comprise instructions to: generate, by an initial authenticator (A2), the private key (xj,x2,j) corresponding to the public key (yj,y2j) previously provided to the relying party (RP) by the further authenticator (A1) using: relying party data (RPj) associated with the relying party and the secret (k) associated with the initial authenticator and the further authenticator.

Clause 39: The machine readable storage of either of clauses 37 and 38, in which the instructions to generate, by the initial authenticator (A2), the private key (xj,x2,j) corresponding to the public key (yj,y2j) previously provided to the relying party (RP) by the further authenticator (A1) comprise instructions to: generate a private-public key pair [(x2,y2),(x2,j,y2,j)] associated with the initial authenticator (A2) using the secret (k) and, optionally, the relying party data (RPj).

Clause 40: The machine readable storage of clause 39, in which the instructions to generate the private-public key pair [(x2,j,y2,j)] associated with the initial authenticator (A2) using the secret (k) and the relying party data (RPj) comprise instructions to: generate a relying party specific private-public key pair [(x2,j,y2,j)] associated with the initial authenticator (A2) using the secret (k), the relying party data (RPj) and an earlier established private-public key pair (x2,y2) associated with the initial authenticator (A2). (PROXY)

Clause 41: The machine readable storage of any of clauses 37 to 40, in which the instructions to output, for sending to the relying party (RP), data proving access to or possession of, by the initial authenticator (A2), the private key (xj,x2,j) corresponding to the public key (yj,y2j) previously provided to the replying party (RP) by the further authenticator (A1) comprise instructions to: output a signature, associated with a plurality of public keys, comprising: a public key (y1j) associated with the further authenticator (A1) and the public key (y2,j) associated with the initial authenticator (A2).

Clause 42: The machine readable storage of clause 41, in which the instruction to output a signature, associated with a plurality of public keys, comprising: a public key (y1j) associated with the further authenticator (A1) and the public key (y2,j) associated with the initial authenticator (A2) comprise instructions to: output a signature associated with a structured data set (List: L=y1,j∥y2,j) comprising the a public key (y1j) associated with the further authenticator (A1) and the public key (y2,j) associated with the initial authenticator (A2).

Clause 43: The machine readable storage of clause 42, in which the signature associated with the structured data set comprises a ring signature for sending to the relying party.

Clause 44: The machine readable storage of clauses 41 to 43, in which the instructions to output, for sending to the relying party (RP), the data proving access to or possession of, by the initial authenticator (A2), the private key (xj,x2,j) corresponding to the public key (yj,y2j) previously provided to the replying party (RP) by the further authenticator (A1) comprise instructions to: output the signature for sending to the relying party.

Clause 45: Machine readable storage storing instructions arranged, when processed, to implement a multiphase authentication protocol comprising a plurality of phases; the storage comprising instructions to: establish an initial phase comprising instructions to establish a shared secret associated with an initial authenticator and a further authenticator, establish a registration phase comprising instructions to: establish, by the initial authenticator, public authentication data associated with both the initial authenticator and the further authenticator using the shared secret and, optionally, relying party data associated with a relying party, output the public authentication data to the relying party for associating with a resource to be accessible to the initial authenticator and the further authenticator; establish an authentication phase comprising instructions to: receive, by a receiving authenticator of the initial or further authenticators, relying party data, establish, by the receiving authenticator, a signature associated with the public authentication data, and output the signature to the relying party to gain access to the resource.

Clause 46: The machine readable storage of clause 45, in which the instructions to establish, by the initial authenticator, public authentication data associated with both the initial authenticator and the further authenticator using the shared secret and relying party data associated with a relying party comprise instructions to: establish, by the initial authenticator, private-public authentication data using the shared secret and relying party data associated with the relying party; the private-public authentication data being associated with at least one, or both, of the initial authenticator and the further authenticator.

Clause 47: The machine readable storage of clause 46, in which the instructions to establish, by the initial authenticator, private-public authentication data using the shared secret and relying party data associated with the relying party; the private-public authentication data being associated with at least one, or both, of the initial authenticator and the further authenticator comprise instructions to: establish private-public authentication data associated with the initial authenticator using the secret and relying party data.

Clause 48: The machine readable storage of any of clauses 46 to 47, in which the instructions to establish private-public authentication data associated with the initial authenticator using the secret and relying party data comprise instructions to: establish private-public authentication data associated with the initial authenticator using the secret, relying party data and earlier authentication data associated with the initial authenticator.

Clause 49: The machine readable storage of any clauses 45 to 48, in which the instructions to establish, by the initial authenticator, private-public authentication data using the shared secret and relying party data associated with the relying party; the private-public authentication data being associated with at least one, or both, of the initial authenticator and the further authenticator, comprise instructions to: establish public authentication data associated with the further authenticator using the secret and relying party data.

Clause 50: The machine readable storage of clause 49, in which the instruction to establish public authentication data associated with the further authenticator using the secret and relying party data comprise instructions to: establish public authentication data associated with the further authenticator using the secret, relying party data and earlier authentication data associated with the further authenticator.

Clause 51: The machine readable storage of any of clauses 45 to 50, in which the resource is an account associated with the initial authenticator and the further authenticator.

Clause 52: A system or device for authentication using an authenticator, the system or device comprising logic to: generate, by an initial authenticator (A1), a public key (yj,y2,j) associated with a further authenticator (A2) using a secret (k) associated with the initial authenticator and the further authenticator; and output the public key associated with the further authenticator for sending to a relying party.

Clause 53: The system or device of clause 52, in which the logic to generate, by an initial authenticator (A1), a public key (yj,y2,j) associated with a further authenticator (A2) using a secret (k) associated with the initial authenticator and the further authenticator comprises logic to: generate, by an initial authenticator (A1), a public key (yj,y2,j) associated with a further authenticator (A2) using relying party data (RPj) associated with the relying party and the secret (k) associated with the initial authenticator and the further authenticator.

Clause 54: The system or device of clause 53, in which the logic to generate, by the initial authenticator (A1), the public key (yj,y2,j) associated with the further authenticator (A2) using the secret (k) and the relying party data (RPj) comprises logic to: generate a private-public key pair [(x1,y1), (x1,j,y1,j)] associated with the initial authenticator using the secret and the relying party data.

Clause 55: The system or device of clause 54 comprising logic to set the public key (y2) associated with the further authenticator to equal the public key associated with the initial authenticator.

Clause 56: The system or device of either of clauses 54 and 55, in which the logic to generate the private-public key pair [(x1,j,y1,j)] associated with the initial authenticator using the secret and the relying party data comprises logic to: generate a relying party specific private-public key pair [(x1,j,y1,j)] associated with the initial authenticator using the secret, the relying party data and an earlier established private-public key pair (x1,y1) associated with the initial authenticator, and in which the logic to output the public key associated with the further authenticator for sending to the relying party comprise logic to: output the relying party specific public key (y1,j) associated with the initial authenticator for sending to the relying party.

Clause 57: The system or device of any preceding clause, in which the logic to generate the public key (y2,j) associated with the further authenticator using the secret (k) and the relying party data (RPj) comprises logic to: generate a relying party specific public key (y2,j) associated with the further authenticator using the secret, the relying party data and an earlier established public key (y2) associated with the further authenticator, and in which the logic to output the public key associated with the further authenticator for sending to the relying party comprises logic: to output the relying party specific public key (y2,j) associated with the further authenticator for sending to the relying party.

Clause 58: The system or device of any of clauses 52 to 57, in which the logic to output the public key associated with the further authenticator for sending to the relying party comprises logic to: output a structured data set (L=y1,j∥y2,j), comprising the public key associated with the further authenticator; the structured data set being associated a ring signature for sending to the relying party. (RING)

Clause 59: The system or device of clause 58, in which the logic to output the structured data set (list, L=y1,j∥y2,j), comprising the public key associated with the further authenticator, comprises logic to: output a structured data set (list, L=y1,j∥y2,j) comprising the public key (y2,j) associated with the further authenticator (A2) and a public key (y1,j) associated with the initial authenticator (A1).

Clause 60: The system or device of any of clauses 52 to 59, further comprising logic to: generate a signature using at least the private key associated with the further authenticator, and output the signature for sending to the relying party.

Clause 61: A system or device to authenticate a user, or a user device, to a relying party (RP) using an authenticator, the system or device comprising logic to: generate, by an initial authenticator (A2), a private key (xj,x2,j) corresponding to a public key (yj,y2j) previously provided to the relying party (RP) by a further authenticator (A1) using: relying party data (RPj) associated with the relying party, and a secret (k) associated with the initial authenticator and the further authenticator; and output, for sending to the relying party (RP), data proving access to or possession of, by the initial authenticator (A2), the private key (xj,x2,j) corresponding to the public key (yj,y2j) previously provided to the replying party (RP) by the further authenticator (A1).

Clause 62: The system or device of clause 61, in which the logic to generate, by an initial authenticator (A2), the private key (xj,x2,j) corresponding to the public key (yj,y2j) previously provided to the relying party (RP) by a further authenticator (A1) using: a secret (k) associated with the initial authenticator and the further authenticator, comprises logic to: generate, by an initial authenticator (A2), the private key (xj,x2,j) corresponding to the public key (yj,y2j) previously provided to the relying party (RP) by the further authenticator (A1) using: relying party data (RPj) associated with the relying party and the secret (k) associated with the initial authenticator and the further authenticator.

Clause 63: The system or device of either of clauses 61 and 62, in which the logic to generate, by the initial authenticator (A2), the private key (xj,x2,j) corresponding to the public key (yj,y2j) previously provided to the relying party (RP) by the further authenticator (A1) comprises logic to: generate a private-public key pair [(x2,y2),(x2,j,y2,j)] associated with the initial authenticator (A2) using the secret (k) and, optionally, the relying party data (RPj).

Clause 64: The system or device of clause 63, in which the logic to generate the private-public key pair [(x2,j,y2,j)] associated with the initial authenticator (A2) using the secret (k) and the relying party data (RPj) comprises logic to: generate a relying party specific private-public key pair [(x2,j,y2,j)] associated with the initial authenticator (A2) using the secret (k), the relying party data (RPj) and an earlier established private-public key pair (x2,y2) associated with the initial authenticator (A2). (PROXY)

Clause 65: The system or device of any of clauses 61 to 64, in which the logic to output, for sending to the relying party (RP), data proving access to or possession of, by the initial authenticator (A2), the private key (xj,x2,j) corresponding to the public key (yj,y2j) previously provided to the replying party (RP) by the further authenticator (A1) comprises logic to: output a signature, associated with a plurality of public keys, comprising: a public key (y1j) associated with the further authenticator (A1) and the public key (y2,j) associated with the initial authenticator (A2).

Clause 66: The system or device of clause 65, in which the logic to output a signature, associated with a plurality of public keys, comprising: a public key (y1j) associated with the further authenticator (A1) and the public key (y2,j) associated with the initial authenticator (A2) comprises logic to: output a signature associated with a structured data set (List: L=y1,j∥y2,j), comprising the public key (y1j) associated with the further authenticator (A1) and the public key (y2,j) associated with the initial authenticator (A2).

Clause 67: The system or device of clause 66, in which the signature associated with the structured data set comprises a ring signature for sending to the relying party.

Clause 68: The system or device of clauses 65 to 67, in which the logic to output, for sending to the relying party (RP), the data proving access to or possession of, by the initial authenticator (A2), the private key (xj,x2,j) corresponding to the public key (yj,y2j) previously provided to the replying party (RP) by the further authenticator (A1) comprises logic to: output the signature for sending to the relying party.

Clause 69: A system or device to implement a multiphase authentication protocol comprising a plurality of phases; the system comprising logic to: establish an initial phase comprising logic to establish a shared secret associated with an initial authenticator and a further authenticator; establish a registration phase comprising logic to: establish, by the initial authenticator, public authentication data associated with both the initial authenticator and the further authenticator using the shared secret and, optionally, relying party data associated with a relying party, output the public authentication data to the relying party for associating with a resource to be accessible to the initial authenticator and the further authenticator and establish an authentication phase comprising logic to: receive, by a receiving authenticator of the initial or further authenticators, relying party data, establish, by the receiving authenticator, a signature associated with the public authentication data, and output the signature to the relying party to gain access to the resource.

Clause 70: The system or device of clause 69, in which the logic to establish, by the initial authenticator, public authentication data associated with both the initial authenticator and the further authenticator using the shared secret and relying party data associated with a relying party comprises logic to: establish, by the initial authenticator, private-public authentication data using the shared secret and relying party data associated with the relying party; the private-public authentication data being associated with at least one, or both, of the initial authenticator and the further authenticator.

Clause 71: The system or device of clause 70, in which the logic to establish, by the initial authenticator, private-public authentication data using the shared secret and relying party data associated with the relying party; the private-public authentication data being associated with at least one, or both, of the initial authenticator and the further authenticator comprises logic to: establish private-public authentication data associated with the initial authenticator using the secret and relying party data.

Clause 72: The system or device of any of clauses 70 to 71, in which the logic to establish private-public authentication data associated with the initial authenticator using the secret and relying party data comprises logic to: establish private-public authentication data associated with the initial authenticator using the secret, relying party data and earlier authentication data associated with the initial authenticator.

Clause 73: The system or device of any clauses 69 to 72, in which the logic to establish, by the initial authenticator, private-public authentication data using the shared secret and relying party data associated with the relying party; the private-public authentication data being associated with at least one, or both, of the initial authenticator and the further authenticator, comprises logic to: establish public authentication data associated with the further authenticator using the secret and relying party data.

Clause 74: The system or device of clause 73, in which the logic to establish public authentication data associated with the further authenticator using the secret and relying party data comprises logic to: establish public authentication data associated with the further authenticator using the secret, relying party data and earlier authentication data associated with the further authenticator.

75. Clause 75: The system or device of any of clauses 69 to 74, in which the resource is an account associated with the initial authenticator and the further authenticator.

1. Machine readable storage storing instructions arranged, when processed, to implement authentication using an authenticator, the instructions comprising instructions to:
a. generate, by an initial authenticator, a public key associated with a further authenticator using a secret associated with the initial authenticator and the further authenticator; and
b. output the public key associated with the further authenticator for sending to a relying party.

2. The machine readable storage of claim 1, in which the instructions to generate, by an initial authenticator, a public key associated with a further authenticator using secret associated with the initial authenticator and the further authenticator comprise instructions to:
a. generate, by an initial authenticator, a public key associated with the further authenticator using relying party data associated with the relying party and the secret associated with the initial authenticator and the further authenticator.

3. The machine readable storage of claim 2, in which the instructions to generate, by the initial authenticator, the public key associated with the further authenticator using the secret and the relying party data comprise instructions to:
a. generate a private-public key pair associated with the initial authenticator using the secret and the relying party data.

4. The machine readable storage of claim 3, comprising instructions to set the public key associated with the further authenticator to equal the public key associated with the initial authenticator.

5. The machine readable storage of claim 3, in which the instructions to generate the private-public key pair associated with the initial authenticator using the secret and the relying party data comprise instructions to:
a. generate a relying party specific private-public key pair associated with the initial authenticator using the secret, the relying party data and an earlier established private-public key pair associated with the initial authenticator, and
b. in which the instructions to output the public key associated with the further authenticator for sending to the relying party comprise instructions to: output the replying party specific public key associated with the initial authenticator for sending to the relying party.

6. The machine readable storage of claim 1, in which the instructions to generate the public key associated with the further authenticator using the secret and the relying party data comprise instructions to:
a. generate a relying party specific public key associated with the further authenticator using the secret, the relying party data and an earlier established public key associated with the further authenticator, and
b. in which the instructions to output the public key associated with the further authenticator for sending to the relying party comprise instructions to: output the unique/replying party specific public key associated with the further authenticator for sending to the relying party.

7. The machine readable storage of claim 1, in which the instructions to output the public key associated with the further authenticator for sending to the relying party comprise instructions to:
a. output a structured data set, comprising the public key associated with the further authenticator; the structured data set being associated with a ring signature for sending to the relying party.

8. The machine readable storage of claim 7, in which the instructions to output the structured data set, comprising the public key associated with the further authenticator comprise instructions to:
a. output a structured data set comprising the public key associated with the further authenticator and a public key associated with the initial authenticator.

9. The machine readable storage of claim 1, further comprising instructions to:
a. generate a signature using at least a private key associated with the further authenticator, and
b. output the signature for sending to the relying party.

10. A multiphase authentication system comprising a plurality of phases; the system comprising logic to:
a. establish an initial phase comprising logic to establish a shared secret associated with an initial authenticator and a further authenticator,
b. establish a registration phase comprising logic to:
establish, by the initial authenticator, public authentication data associated with both the initial authenticator and the further authenticator using the shared secret, and
output the public authentication data to the relying party for associating with a resource to be accessible to the initial authenticator and the further authenticator;
c. establish an authentication phase comprising logic to:
receive, by a receiving authenticator of the initial or further authenticators, relying party data, establish, by the receiving authenticator, a signature associated with the public authentication data, and output the signature to the relying party to gain access to a resource.

11. The system of claim 10, in which the logic to establish, by the initial authenticator, public authentication data associated with both the initial authenticator and the further authenticator using the shared secret comprises logic to:
a. establish, by the initial authenticator, private-public authentication data using the shared secret and relying party data associated with the relying party; the private-public authentication data being associated with at least one of the initial authenticator and the further authenticator.

12. The system of claim 11, in which the logic to establish, by the initial authenticator, private-public authentication data using the shared secret and relying party data associated with the relying party; the private-public authentication data being associated with at least one of the initial authenticator and the further authenticator comprises logic to:
a. establish private-public authentication data associated with the initial authenticator using the secret and the relying party data.

13. The system claim 11, in which the logic to establish private-public authentication data associated with the initial authenticator using the secret and relying party data comprise logics to:
a. establish private-public authentication data associated with the initial authenticator using the secret, relying party data and earlier authentication data associated with the initial authenticator.

14. The system of claim 10, in which the logic to establish, by the initial authenticator, private-public authentication data using the shared secret; the private-public authentication data being associated with at least one of the initial authenticator and the further authenticator, comprises logic to:
a. establish public authentication data associated with the further authenticator using the secret and relying party data.

15. The system of claim 14, in which the instructions to establish public authentication data associated with the further authenticator using the secret and relying party data comprises logic to:
a. establish public authentication data associated with the further authenticator using the secret, relying party data and earlier authentication data associated with the further authenticator.
